(19) United States
(12) Patent Application Publication
(10) Pub. No.: US 2015/0033968 A1
(43) Pub. Date: Feb. 5, 2015

(54) OPTICAL ALIGNMENT OF MULTI-STATION FLEXOGRAPHIC PRINTING SYSTEM USING MOIRE INTERFERENCE

(71) Applicant: Uni-Pixel Displays, Inc., The Woodlands, TX (US)

(72) Inventors: Kevin J. Derichs, Buda, TX (US); Evan M. Goldberg, The Woodlands, TX (US); Christopher Derichs, Buda, TX (US)

(21) Appl. No.: 14/518,923

(22) Filed: Oct. 20, 2014

Related U.S. Application Data
(63) Continuation-in-part of application No. 13/851,933, filed on Mar. 27, 2013.
Application No. 13/851,933 is a continuation-in-part of application No. 14/177,091, filed on Feb. 10, 2014.

(51) Int. Cl. B41F 27/00; B41F 5/24

(52) U.S. Cl. CPC B41F 27/005; B41F 5/24
USPC 101/481; 101/485

(57) ABSTRACT

A method of aligning a multi-station flexographic printing system using Moiré interference includes printing, using a first flexographic printing station, at least one Moiré interference pattern in a unique location on a first side of a substrate for each of at least one subsequent flexographic printing stations of the system. For each of the at least one subsequent flexographic printing stations, at least one inverted Moiré interference pattern is printed on either side of the substrate in a location corresponding to that station's unique location on the substrate. An alignment of at least one of the at least one subsequent flexographic printing stations is adjusted when at least one Moiré interference pattern interferes with a corresponding at least one inverted Moiré interference pattern.

### CROSS-REFERENCE TO RELATED APPLICATIONS

This application is a continuation-in-part of U.S. patent application Ser. No. 13/851,933, filed on Mar. 27, 2013, and is a continuation-in-part of U.S. patent application Ser. No. 14/177,091, filed on Feb. 10, 2014, the contents of both are hereby incorporated by reference in their entirety.

### BACKGROUND OF THE INVENTION

A touch screen enabled system allows a user to control various aspects of the system by touch or gestures on the screen. A user may interact directly with one or more objects depicted on a display device by touch or gestures that are sensed by a touch sensor. The touch sensor typically includes a conductive pattern disposed on a substrate configured to sense touch. Touch screens are commonly used in consumer, commercial, and industrial systems.

### BRIEF SUMMARY OF THE INVENTION

According to one aspect of one or more embodiments of the present invention, a method of aligning a multi-station flexographic printing system using Moiré interference includes printing, using a first flexographic printing station, at least one Moiré interference pattern in a unique location on a first side of a substrate for each of at least one subsequent flexographic printing stations of the system. For each of the at least one subsequent flexographic printing stations, at least one inverted Moiré interference pattern is printed on either side of the substrate in a location corresponding to that station's unique location on the substrate. An alignment of at least one of the at least one subsequent flexographic printing stations is adjusted when at least one Moiré interference pattern interferes with a corresponding at least one inverted Moiré interference pattern.

According to one aspect of one or more embodiments of the present invention, a multi-station flexographic printing system includes a first flexographic printing station configured to print on a substrate and at least one subsequent flexographic printing station configured to print on the substrate. The first flexographic printing station prints at least one Moiré interference pattern in a unique location on a first side of the substrate for each of the at least one subsequent flexographic printing stations of the system. Each of the at least one subsequent flexographic printing stations prints at least one inverted Moiré interference pattern on either side of the substrate in a location corresponding to that station's unique location on the substrate.

Other aspects of the present invention will be apparent from the following description and claims.

### BRIEF DESCRIPTION OF THE DRAWINGS

FIG. 1 shows a cross section of a touch screen in accordance with one or more embodiments of the present invention.

FIG. 2 shows a schematic view of a touch screen enabled computing system in accordance with one or more embodiments of the present invention.

FIG. 3 shows a functional representation of a touch sensor as part of a touch screen in accordance with one or more embodiments of the present invention.

FIG. 4A shows a cross section of a touch sensor with conductive patterns disposed on opposing sides of a transparent substrate in accordance with one or more embodiments of the present invention.

FIG. 4B shows a cross section of a touch sensor with a first conductive pattern disposed on a first transparent substrate and a second conductive pattern disposed on a second transparent substrate in accordance with one or more embodiments of the present invention.

FIG. 4C shows a cross section of a touch sensor with a first conductive pattern disposed on a first transparent substrate and a second conductive pattern disposed on a second transparent substrate in accordance with one or more embodiments of the present invention.

FIG. 4D shows a cross section of a touch sensor with a first conductive pattern disposed on a first transparent substrate and a second conductive pattern disposed on a second transparent substrate in accordance with one or more embodiments of the present invention.

FIG. 5 shows a first conductive pattern disposed on a transparent substrate in accordance with one or more embodiments of the present invention.

FIG. 6 shows a second conductive pattern disposed on a transparent substrate in accordance with one or more embodiments of the present invention.

FIG. 7 shows a portion of a touch sensor in accordance with one or more embodiments of the present invention.

FIG. 8 shows a flexographic printing station in accordance with one or more embodiments of the present invention.

FIG. 9 shows a multi-station flexographic printing system 900 in accordance with one or more embodiments of the present invention.

FIG. 10A shows a Moiré interference pattern in accordance with one or more embodiments of the present invention.

FIG. 10B shows an inverted Moiré interference pattern in accordance with one or more embodiments of the present invention.

FIG. 11A shows a Moiré interference pattern and an inverted Moiré interference pattern that do not overlap in accordance with one or more embodiments of the present invention.

FIG. 11B shows an inverted Moiré interference pattern that partially overlaps a Moiré interference pattern in accordance with one or more embodiments of the present invention.

FIG. 11C shows an inverted Moiré interference pattern that substantially overlaps a Moiré interference pattern in accordance with one or more embodiments of the present invention.

FIG. 11D shows an inverted Moiré interference pattern that overlaps and is center-aligned to a Moiré interference pattern in accordance with one or more embodiments of the present invention.

FIG. 11E shows a Moiré interference pattern and a shrunken inverted Moiré interference pattern that do not overlap in accordance with one or more embodiments of the present invention.

FIG. 11F shows a shrunken inverted Moiré interference pattern that partially overlaps a Moiré interference pattern in accordance with one or more embodiments of the present invention.

FIG. 11G shows a Moiré interference pattern and an inverted Moiré interference pattern elongated along one axis that do not overlap in accordance with one or more embodiments of the present invention.

FIG. 11H shows an inverted Moiré interference pattern elongated along one axis that partially overlaps a Moiré interference pattern in accordance with one or more embodiments of the present invention.

FIG. 12A shows a plurality of Moiré interference patterns disposed on substrate by a first flexographic printing station in accordance with one or more embodiments of the present invention.

FIG. 12B shows a plurality of inverted Moiré interference patterns disposed on substrate by subsequent flexographic printing stations in accordance with one or more embodiments of the present invention.

FIG. 13 shows a printed transparent substrate in accordance with one or more embodiments of the present invention.

FIG. 14A shows a squared Moiré interference pattern in accordance with one or more embodiments of the present invention.

FIG. 14B shows a squared inverted Moiré interference pattern in accordance with one or more embodiments of the present invention.

FIG. 15A shows a squared Moiré interference pattern and a squared inverted Moiré interference pattern that do not overlap in accordance with one or more embodiments of the present invention.

FIG. 15B shows a squared Moiré interference pattern that partially overlaps a squared inverted Moiré interference pattern in accordance with one or more embodiments of the present invention.

FIG. 15C shows a squared Moiré interference pattern that substantially overlaps a squared inverted Moiré interference pattern in accordance with one or more embodiments of the present invention.

FIG. 15D shows a squared Moiré interference pattern that overlaps and is center-aligned to a squared inverted Moiré interference pattern in accordance with one or more embodiments of the present invention.

FIG. 16 shows a method of aligning a multi-station flexographic printing system using Moiré interference in accordance with one or more embodiments of the present invention.

FIG. 17 shows the relationship between the trace width, the space width, the pitch space, and the offset displacement between the centers of a Moiré interference pattern and an inverted Moiré interference pattern and the perception of Moiré interference in accordance with one or more embodiments of the present invention.

FIG. 18 shows an example of how a reduction in dimensions of trace width and space width may increase alignment accuracy using the same offset displacement in accordance with one or more embodiments of the present invention.

FIG. 19 shows the relationship between offset displacement between the centers of Moiré interference pattern and inverted Moiré interference pattern when the offset displacement is less than the width of a single trace width in accordance with one or more embodiments of the present invention.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention.

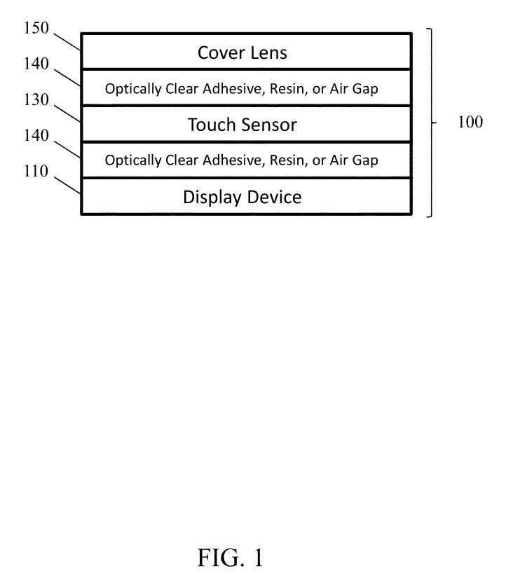

FIG. 1 shows a cross-section of a touch screen 100 in accordance with one or more embodiments of the present invention. Touch screen 100 includes a display device 110. Display device 110 may be a Liquid Crystal Display (“LCD”), Light-Emitting Diode (“LED”), Organic Light-Emitting Diode (“OLED”), Active Matrix Organic Light-Emitting Diode (“AMOLED”), In-Plane Switching (“IPS”), or other type of display device suitable for use as part of a touch screen application or design. In one or more embodiments of the present invention, touch screen 100 may include a touch sensor 130 that overlays at least a portion of a viewable area of display device 110. The viewable area of display device 110 may include the area defined by the light emitting pixels (not shown) of the display device 110 that are typically viewable to an end user. In certain embodiments, an optically clear adhesive or resin 140 may bond a bottom side of touch sensor 130 to a top, or user-facing, side of display device 110. In other embodiments, an isolation layer, or air gap, 140 may separate the bottom side of touch sensor 130 from the top, or user-facing, side of display device 110. A cover lens 150 may overlay a top, or user-facing, side of touch sensor 130. Cover lens 150 may be composed of glass, plastic, film, or other material. In certain embodiments, an optically clear adhesive or resin 140 may bond a bottom side of cover lens 150 to the top, or user-facing, side of touch sensor 130. In other embodiments, an isolation layer, or air gap, 140 may separate the bottom side of cover lens 150 and the top, or user-facing, side of touch sensor 130. A top side of cover lens 150 may face the user and protect the underlying components of touch screen 100. In one or more embodiments of the present invention, touch sensor 130, or the function that it implements, may be integrated into the display device 110 stack (not independently illustrated). One of ordinary skill in the art will recognize that touch sensor 130 may be a capacitive, resistive, optical, acoustic, or any other type of touch sensor technology capable of sensing touch. One of ordinary skill in the art will also recognize that the components or the stackup of touch screen 100 may vary based on an application or design.

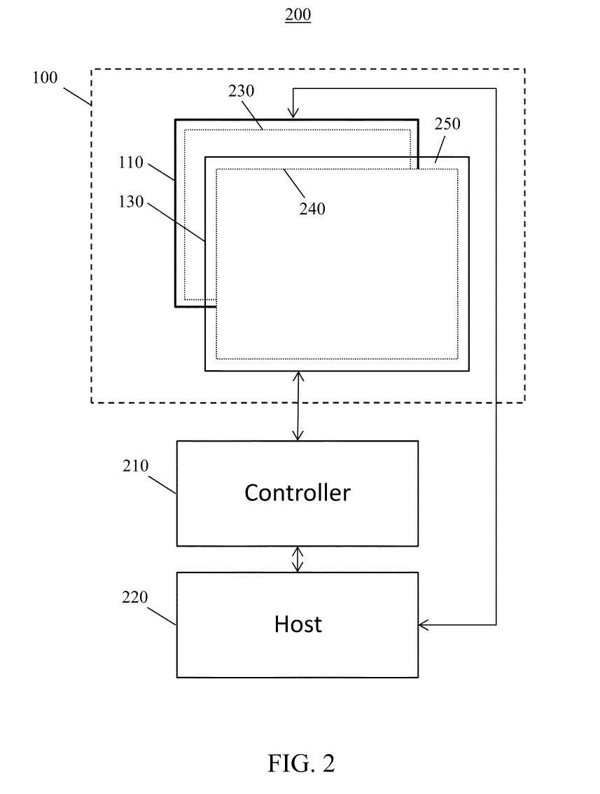

FIG. 2 shows a schematic view of a touch screen enabled system 200 in accordance with one or more embodiments of the present invention. System 200 may be a consumer system, commercial system, or industrial system including, but not limited to, a smartphone, tablet computer, laptop computer, desktop computer, printer, monitor, television, appliance, kiosk, automatic teller machine, copier, desktop phone, automotive display system, portable gaming device, gaming console, or other application or design suitable for use with touch screen 100.

System 200 may include one or more printed circuit boards or flex circuits (not shown) on which one or more processors (not shown), system memory (not shown), and other system components (not shown) may be disposed. Each of the one or more processors may be a single-core processor (not shown) or a multi-core processor (not shown) capable of executing software instructions. Multi-core processors typically include a plurality of processor cores disposed on the same physical die (not shown) or a plurality of processor cores disposed on multiple die (not shown) disposed within the same mechanical package (not shown). System 200 may include one or more input/output devices (not shown), one or more local storage devices (not shown) including solid-state memory, a fixed disk drive, a fixed disk drive array, or any other non-transitory computer readable medium, a network interface device (not shown), and/or one or more network storage devices (not shown) including a network-attached storage device and a cloud-based storage device.

In certain embodiments, touch screen 100 may include touch sensor 130 that overlays at least a portion of a viewable area 230 of display device 110. Touch sensor 130 may include a viewable area 240 that corresponds to that portion of the touch sensor 130 that overlays the light emitting pixels (not shown) of display device 110. Touch sensor 130 may include a bezel circuit 250 outside at least one side of the viewable area 240 that provides connectivity between touch sensor 130 and a controller 210. In other embodiments, touch sensor 130, or the function that it implements, may be integrated into display device 110 (not independently illustrated). Controller 210 electrically drives at least a portion of touch sensor 130. Touch sensor 130 senses touch (capacitance, resistance, optical, acoustic, or other technology) and conveys information corresponding to the sensed touch to controller 210.

The manner in which the sensing of touch is measured, tuned, and/or filtered may be configured by controller 210. In addition, controller 210 may recognize one or more gestures based on the sensed touch or touches. Controller 210 provides host 220 with touch or gesture information corresponding to the sensed touch or touches. Host 220 may use this touch or gesture information as user input and respond in an appropriate manner. In this way, the user may interact with system 200 by touch or gestures on touch screen 100. In certain embodiments, host 220 may be the one or more printed circuit boards or flex circuits (not shown) on which the one or more processors (not shown) are disposed. In other embodiments, host 220 may be a subsystem or any other part of system 200 that is configured to interface with display device 110 and controller 210. One of ordinary skill in the art will recognize that the components and configuration of the components of system 200 may vary based on an application or design in accordance with one or more embodiments of the present invention.

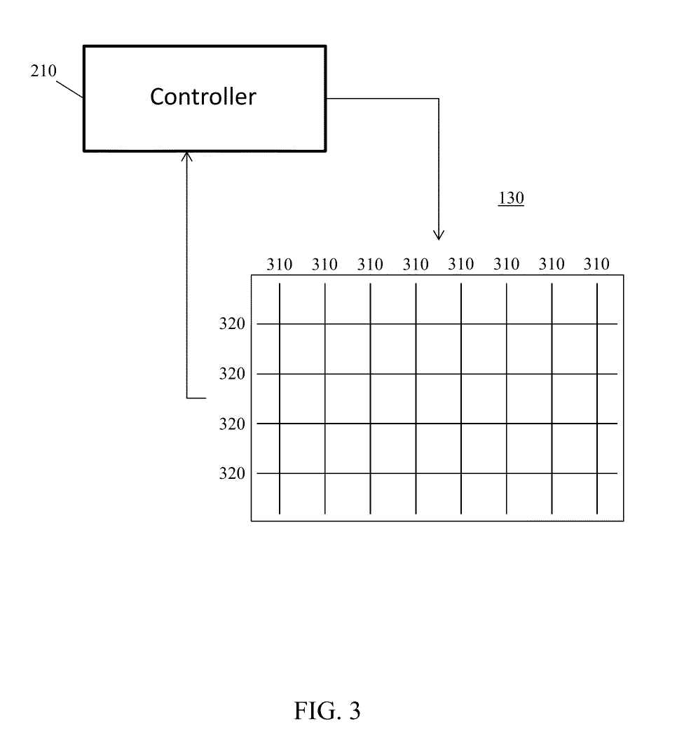

FIG. 3 shows a functional representation of a touch sensor 130 as part of a touch screen 100 in accordance with one or more embodiments of the present invention. In certain embodiments, touch sensor 130 may be viewed as a plurality of column channels 310 and a plurality of row channels 320 arranged as a mesh grid. The number of column channels 310 and the number of row channels 320 may not be the same and may vary based on an application or a design. The apparent intersections of column channels 310 and row channels 320 may be viewed as uniquely addressable locations of touch sensor 130. In operation, controller 210 may electrically drive one or more row channels 320 and touch sensor 130 may sense touch on one or more column channels 310 that are sampled by controller 210. One of ordinary skill in the art will recognize that the role of row channels 320 and column channels 310 may be reversed such that controller 210 electrically drives one or more column channels 310 and touch sensor 130 senses touch on one or more row channels 320 that are sampled by controller 210.

In certain embodiments, controller 210 may interface with touch sensor 130 by a scanning process. In such an embodiment, controller 210 may electrically drive a selected row channel 320 (or column channel 310) and sample all column channels 310 (or row channels 320) that intersect the selected row channel 320 (or the selected column channel 310) by sensing, for example, changes in capacitance at each intersection. This process may be continued through all row channels 320 (or all column channels 310) such that capacitance is measured at each uniquely addressable location of touch sensor 130 at predetermined intervals. Controller 210 may allow for the adjustment of the scan rate depending on the needs of a particular application or design. One of ordinary skill in the art will recognize that the scanning process discussed above may also be used with other touch sensor technologies in accordance with one or more embodiments of the present invention. In other embodiments, controller 210 may interface with touch sensor 130 by an interrupt driven process. In such an embodiment, a touch or a gesture generates an interrupt to controller 210 that triggers controller 210 to read one or more of its own registers that store sensed touch information sampled from touch sensor 130 at predetermined intervals. One of ordinary skill in the art will recognize that the mechanism by which touch or gestures are sensed by touch sensor 130 and sampled by controller 210 may vary based on an application or a design in accordance with one or more embodiments of the present invention.

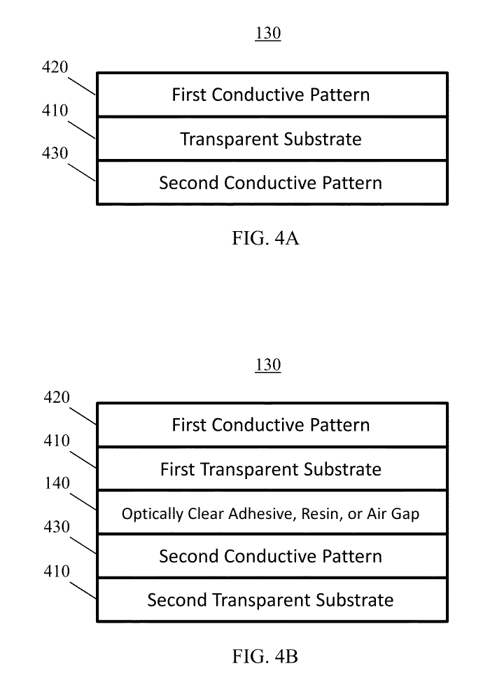

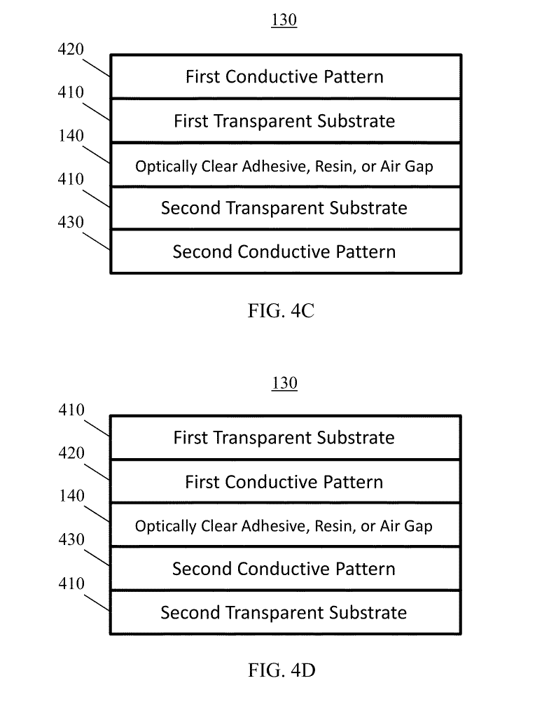

FIG. 4A shows a cross section of a touch sensor 130 with conductive patterns 420 and 430 disposed on opposing sides of a transparent substrate 410 in accordance with one or more embodiments of the present invention. In certain embodiments, touch sensor 130 may include a first conductive pattern 420 disposed on a top, or user-facing, side of a transparent substrate 410 and a second conductive pattern 430 disposed on a bottom side of the transparent substrate 410. The first conductive pattern 420 may overlay the second conductive pattern 430 at a predetermined alignment that may include an offset. One of ordinary skill in the art will recognize that a conductive pattern may be any shape or pattern of one or more conductors in accordance with one or more embodiments of the present invention.

FIG. 4B shows a cross section of a touch sensor 130 with a first conductive pattern 420 disposed on a first transparent substrate 410 and a second conductive pattern 430 disposed on a second transparent substrate 410 in accordance with one or more embodiments of the present invention. In certain embodiments, touch sensor 130 may include first conductive pattern 420 disposed on a top, or user-facing, side of the first transparent substrate 410 and second conductive pattern 430 disposed on a top side of the second transparent substrate 410. The first conductive pattern 420 may overlay the second conductive pattern 430 at a predetermined alignment that may include an offset. In certain embodiments, the first transparent substrate 410 may be bonded to the second transparent substrate 410 by a lamination process (not shown). In other embodiments, the first transparent substrate 410 may be bonded to the second transparent substrate 410 by an optically clear adhesive or resin 140. In still other embodiments, the first transparent substrate 410 and the second transparent substrate 410 may be secured in place and there may be an isolation layer, or air gap, 140 disposed between the bottom side of the first transparent substrate 410 and the second conductive pattern 430 disposed on the top side of the second transparent substrate 410.

FIG. 4C shows a cross section of a touch sensor 130 with a first conductive pattern 420 disposed on a first transparent substrate 410 and a second conductive pattern 430 disposed on a second transparent substrate 410 in accordance with one or more embodiments of the present invention. In certain embodiments, touch sensor 130 may include first conductive pattern 420 disposed on a top, or user-facing, side of first transparent substrate 410 and second conductive pattern 430 disposed on a bottom side of second transparent substrate 410. The first conductive pattern 420 may overlay the second conductive pattern 430 at a predetermined alignment that may include an offset. In certain embodiments, the first transparent substrate 410 may be bonded to the second transparent substrate 410 by a lamination process (not shown). In other embodiments, the first transparent substrate 410 may be bonded to the second transparent substrate 410 by an optically clear adhesive or resin 140. In still other embodiments, the first transparent substrate 410 and the second transparent substrate 410 may be secured in place and there may be an isolation layer, or air gap, 140 disposed between the bottom side of the first transparent substrate 410 and the top side of the second transparent substrate 410.

FIG. 4D shows a cross section of a touch sensor 130 with a first conductive pattern 420 disposed on a first transparent substrate 410 and a second conductive pattern 430 disposed on a second transparent substrate 410 in accordance with one or more embodiments of the present invention. In certain embodiments, touch sensor 130 may include first conductive pattern 420 disposed on a bottom side of the first transparent substrate 410 and second conductive pattern 430 disposed on a top side of the second transparent substrate 410. The first conductive pattern 420 may overlay the second conductive pattern 430 at a predetermined alignment that may include an offset. In certain embodiments, the first transparent substrate 410 may be bonded to the second transparent substrate 410 by a lamination process (not shown). In other embodiments, the first transparent substrate 410 may be bonded to the second transparent substrate 410 by an optically clear adhesive or resin 140. In still other embodiments, the first transparent substrate 410 and the second transparent substrate 410 may be secured in place and there may be an isolation layer, or air gap, 140 disposed between the first conductive pattern 420 disposed on the bottom side of the first transparent substrate 410 and the second conductive pattern 430 disposed on the top side of the second transparent substrate 410.

One of ordinary skill in the art will recognize that other touch sensor 130 stackups may be used in accordance with one or more embodiments of the present invention. For example, single-sided touch sensor 130 stackups may include conductors disposed on a single side of a substrate 410 where conductors that cross are isolated from one another by a dielectric material, such as, for example, as used in On Glass Solution (“OGS”) touch sensor 130 embodiments (not shown). Double-sided touch sensor 130 stackups may include conductors disposed on opposing sides of the same substrate 140 (as shown in FIG. 4A) or bonded touch sensor 130 embodiments (as shown in FIGS. 4B through 4D) where conductors are disposed on at least two different sides of at least two different substrates 410. Bonded touch sensor 130 stackups may include, for example, two single-sided substrates 410 bonded together (as shown in FIGS. 4B through 4D), one double-sided substrate 410 bonded to a single-sided substrate 410 (not shown), or a double-sided substrate 410 bonded to another double-sided substrate 410 (not shown). One of ordinary skill in the art will recognize that other touch sensor 130 stackups, including those that vary in the number, the type, the organization, and/or the configuration of substrate(s) and/or conductive pattern(s) are within the scope of one or more embodiments of the present invention. One of ordinary skill in the art will also recognize that one or more of the above-noted touch sensor 130 stackups may be used in applications where touch sensor 130 is integrated into display device 110.

One of ordinary skill in the art will recognize that a conductive pattern (e.g., first conductive pattern 420 or second conductive pattern 430) may be comprised of metal, metal alloys, metal oxides, metal nanowires, metal nanoparticle inks, metal nanoparticle coatings, metallic lines, metallic wires, transparent conductors including Indium Tin Oxide (“ITO”), Poly(3,4-ethylenedioxythiophene) (“PEDOT”), carbon nanotubes, graphene, and/or any other conductive material capable of being disposed on a transparent substrate in accordance with one or more embodiments of the present invention.

A conductive pattern (e.g., first conductive pattern 420 or second conductive pattern 430) may be disposed on one or more transparent substrates 410 by any process suitable for disposing conductive lines or features on substrate. Suitable processes may include, for example, printing processes, vacuum-based deposition processes, solution coating processes, or cure/etch processes that either form conductive lines or features on substrate or form seed lines or features on substrate that may be further processed to form conductive lines or features on substrate. Printing processes may include flexographic printing, including the flexographic printing of a catalytic ink image that may be metallized by an electroless plating process or immersion bath process or direct flexographic printing of conductive ink or other materials, gravure printing, inkjet printing, rotary printing, or stamp printing. Deposition processes may include pattern-based deposition, chemical vapor deposition, electro deposition, physical vapor deposition, or casting. Cure/etch processes may include optical or UV-based photolithography, e-beam/ion-beam lithography, x-ray lithography, interference lithography, scanning probe lithography, imprint lithography, or magneto lithography. One of ordinary skill in the art will recognize that any process or combination of processes, suitable for disposing conductive lines or features on substrate, may be used in accordance with one or more embodiments of the present invention.

With respect to transparent substrate 410, transparent means capable of transmitting a substantial portion of visible light through the substrate suitable for a given touch sensor application or design. In certain embodiments, transparent substrate 410 may be polyethylene terephthalate (“PET”), polyethylene naphthalate (“PEN”), cellulose acetate (“TAC”), cycloaliphatic hydrocarbons (“COP”), polymethylmethacrylates (“PMMA”), polyimide (“PI”), bi-axially-oriented polypropylene (“BOPP”), polyester, polycarbonate, glass, copolymers, blends, or combinations thereof. In other embodiments, transparent substrate 410 may be any other transparent material suitable for use as a touch sensor substrate. One of ordinary skill in the art will recognize that the composition of transparent substrate 410 may vary based on an application or design in accordance with one or more embodiments of the present invention.

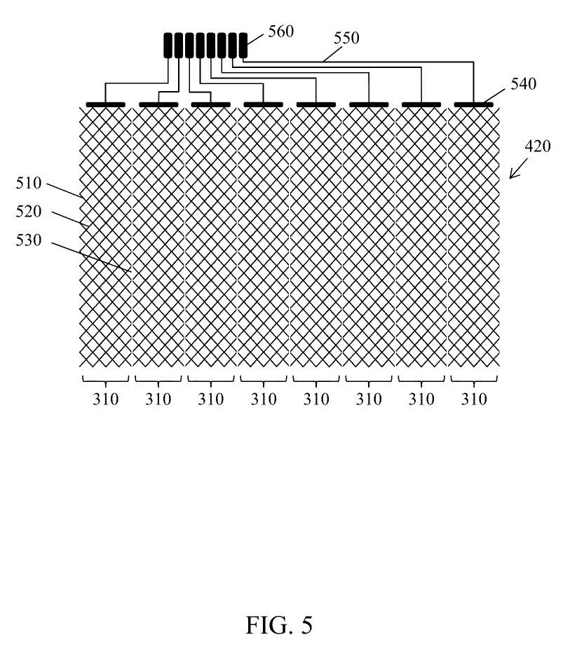

FIG. 5 shows a first conductive pattern 420 disposed on a transparent substrate (e.g., transparent substrate 410) in accordance with one or more embodiments of the present invention. In certain embodiments, first conductive pattern 420 may include a mesh formed by a plurality of parallel conductive lines oriented in a first direction 510 and a plurality of parallel conductive lines oriented in a second direction 520 that are disposed on a side of a transparent substrate (e.g., transparent substrate 410). The plurality of parallel conductive lines oriented in the first direction 510 and the plurality of parallel conductive lines oriented in the second direction 520 may be aligned to one another to provide apertures through first conductive pattern 420. While the alignment may vary based on an application or design, the alignment typically has a small tolerance in touch sensor applications. One of ordinary skill in the art will recognize that the number of parallel conductive lines oriented in the first direction 510 and/or the number of parallel conductive lines oriented in the second direction 520 may vary based on an application or design. One of ordinary skill in the art will also recognize that a size of first conductive pattern 420 may vary based on an application or a design. In other embodiments, first conductive pattern 420 may include any other shape or pattern formed by one or more conductive lines or features (not independently illustrated). One of ordinary skill in the art will recognize that a conductive pattern is not limited to parallel conductive lines and could be any one or more of predetermined orientations of line segments, random orientations of line segments, curved line segments, conductive particles, polygons, or any other shape(s) or pattern(s) comprised of electrically conductive material (not independently illustrated) in accordance with one or more embodiments of the present invention.

In certain embodiments, the plurality of parallel conductive lines oriented in the first direction 510 may be perpendicular to the plurality of parallel conductive lines oriented in the second direction 520, thereby forming the mesh. In other embodiments, the plurality of parallel conductive lines oriented in the first direction 510 may be angled relative to the plurality of parallel conductive lines oriented in the second direction 520, thereby forming the mesh. One of ordinary skill in the art will recognize that the relative angle between the plurality of parallel conductive lines oriented in the first direction 510 and the plurality of parallel conductive lines oriented in the second direction 520 may vary based on an application or a design in accordance with one or more embodiments of the present invention.

In certain embodiments, a plurality of channel breaks 530 may partition first conductive pattern 420 into a plurality of column channels 310, each electrically partitioned and isolated from the others. One of ordinary skill in the art will recognize that the number of channel breaks 530 and the number of column channels 310 may vary based on an application or design in accordance with one or more embodiments of the present invention. Each column line 310 may route to a channel pad 540. Each channel pad 540 may route to an interface connector 560 by way of one or more interconnect conductive lines 550. Interface connectors 560 may provide a connection interface between a touch sensor (e.g., 130 of FIG. 1) and a controller (e.g., 210 of FIG. 2).

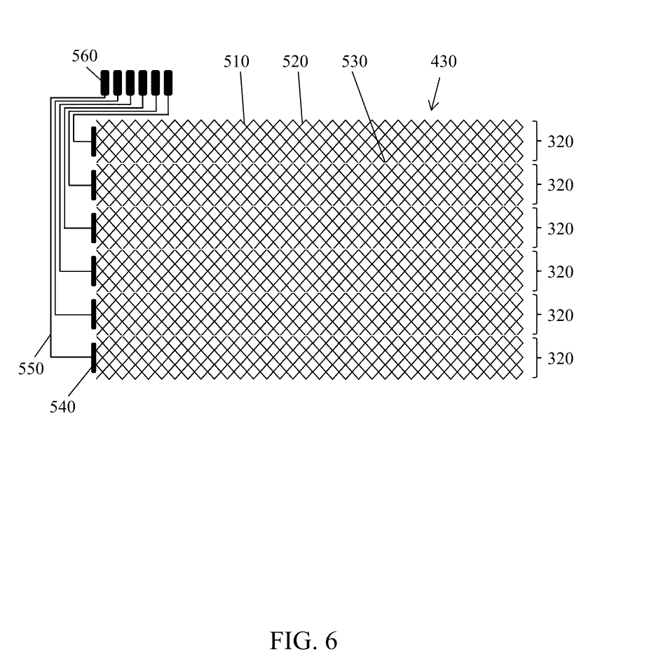

FIG. 6 shows a second conductive pattern 430 disposed on a transparent substrate (e.g., transparent substrate 410) in accordance with one or more embodiments of the present invention. In certain embodiments, second conductive pattern 430 may include a mesh formed by a plurality of parallel conductive lines oriented in a first direction 510 and a plurality of parallel conductive lines oriented in a second direction 520 that are disposed on a side of a transparent substrate (e.g., transparent substrate 410). The plurality of parallel conductive lines oriented in the first direction 510 and the plurality of parallel conductive lines oriented in the section direction 520 may be aligned to one another to provide apertures through second conductive pattern 430. While the alignment may vary based on an application or design, the alignment typically has a small tolerance in touch sensor applications. One of ordinary skill in the art will recognize that the number and the angle of parallel conductive lines oriented in the first direction 510 and/or the number and the angle of parallel conductive lines oriented in the second direction 520 may vary based on an application or design. In certain embodiments, the second conductive pattern 430 may be substantially similar in size to the first conductive pattern 420. One of ordinary skill in the art will recognize that a size of the second conductive pattern 430 may vary based on an application or a design. In other embodiments, second conductive pattern 430 may include any other shape or pattern formed by one or more conductive lines or features (not independently illustrated). One of ordinary skill in the art will recognize that a conductive pattern is not limited to parallel conductive lines and could be any one or more of predetermined orientations of line segments, random orientations of line segments, curved line segments, conductive particles, polygons, or any other shape(s) or pattern(s) comprised of electrically conductive material (not independently illustrated) in accordance with one or more embodiments of the present invention.

In certain embodiments, the plurality of parallel conductive lines oriented in the first direction 510 may be perpendicular to the plurality of parallel conductive lines oriented in the second direction 520, thereby forming the mesh. In other embodiments, the plurality of parallel conductive lines oriented in the first direction 510 may be angled relative to the plurality of parallel conductive lines oriented in the second direction 520, thereby forming the mesh. One of ordinary skill in the art will recognize that the relative angle between the plurality of parallel conductive lines oriented in the first direction 510 and the plurality of parallel conductive lines oriented in the second direction 520 may vary based on an application or a design in accordance with one or more embodiments of the present invention.

In certain embodiments, a plurality of channel breaks 530 may partition second conductive pattern 430 into a plurality of row channels 320, each electrically partitioned and isolated from the others. One of ordinary skill in the art will recognize that the number of channel breaks 530 and the number of row channels 320 may vary based on an application or design in accordance with one or more embodiments of the present invention. Each row line 320 may route to a channel pad 540. Each channel pad 540 may route to an interface connector 560 by way of one or more interconnect conductive lines 550. Interface connectors 560 may provide a connection interface between the touch sensor (e.g., 130 of FIG. 1) and the controller (e.g., 210 of FIG. 2).

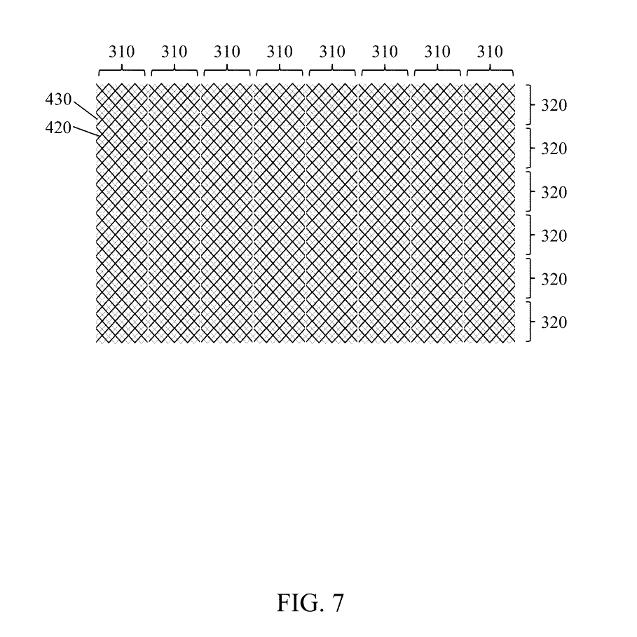

FIG. 7 shows a portion of a touch sensor 130 in accordance with one or more embodiments of the present invention. In certain embodiments, a touch sensor 130 may be formed, for example, by disposing a first conductive pattern 420 on a top, or user-facing, side of a transparent substrate (e.g., transparent substrate 410) and disposing a second conductive pattern 430 on a bottom side of the transparent substrate (e.g., transparent substrate 410). In other embodiments, a touch sensor 130 may be formed, for example, by disposing a first conductive pattern 420 on a side of a first transparent substrate (e.g., transparent substrate 410) and disposing a second conductive pattern 430 on a side of a second transparent substrate (e.g., transparent substrate 410). One of ordinary skill in the art will recognize that the disposition of the conductive pattern or patterns may vary based on the touch sensor 130 stackup in accordance with one or more embodiments of the present invention. In embodiments that use two conductive patterns, the first conductive pattern 420 and the second conductive pattern 430 may be aligned to one another with an offset. While the alignment may vary based on an application or design, the alignment typically has a small tolerance in touch sensor applications. With respect to offset, the first conductive pattern 420 and the second conductive pattern 430 may be horizontally and/or vertically offset relative to one another. The offset between the first conductive pattern 420 and the second conductive pattern 430 may vary based on an application or a design.

In certain embodiments, the first conductive pattern 420 may include a plurality of parallel conductive lines oriented in a first direction (e.g., 510 of FIG. 5) and a plurality of parallel conductive lines oriented in a second direction (e.g., 520 of FIG. 5) that form a mesh that is partitioned by a plurality of breaks (e.g., 530 of FIG. 5) into electrically isolated column channels 310. In certain embodiments, the second conductive pattern 430 may include a plurality of parallel conductive lines oriented in a first direction (e.g., 510 of FIG. 6) and a plurality of parallel conductive lines oriented in a second direction (e.g., 520 of FIG. 6) that form a mesh that is partitioned by a plurality of breaks (e.g., 530 of FIG. 6) into electrically isolated row channels 320. In operation, a controller (e.g., 210 of FIG. 2) may electrically drive one or more row channels 320 (or column channels 310) and touch sensor 130 senses touch on one or more column channels 310 (or row channels 320) sampled by the controller (e.g., 210 of FIG. 2). In other embodiments, the disposition and/or the role of the first conductive pattern 420 and the second conductive pattern 430 may be reversed.

In certain embodiments, one or more of the plurality of parallel conductive lines oriented in a first direction (e.g., 510 of FIG. 5 or FIG. 6), one or more of the plurality of parallel conductive lines oriented in a second direction (e.g., 520 of FIG. 5 or FIG. 6), one or more of the plurality of channel breaks (e.g., 530 of FIG. 5 or FIG. 6), one or more of the plurality of channel pads (e.g., 540 of FIG. 5 or FIG. 6), one or more of the plurality of interconnect conductive lines (e.g., 550 of FIG. 5 or FIG. 6), and/or one or more of the plurality of interface connectors (e.g., 560 of FIG. 5 or FIG. 6) of the first conductive pattern 420 or second conductive pattern 430 may have different line widths and/or different orientations. In addition, the number of parallel conductive lines oriented in the first direction (e.g., 510 of FIG. 5 or FIG. 6), the number of parallel conductive lines oriented in the second direction (e.g., 520 of FIG. 5 or FIG. 6), and the line-to-line spacing between them may vary based on an application or a design. One of ordinary skill in the art will recognize that the size, configuration, and design of each conductive pattern may vary based on an application or a design in accordance with one or more embodiments of the present invention.

In certain embodiments, one or more of the plurality of parallel conductive lines oriented in the first direction (e.g., 510 of FIG. 5 or FIG. 6) and one or more of the plurality of parallel conductive lines oriented in the second direction (e.g., 520 of FIG. 5 or FIG. 6) may have a line width less than approximately 5 micrometers. In other embodiments, one or more of the plurality of parallel conductive lines oriented in the first direction (e.g., 510 of FIG. 5 or FIG. 6) and one or more of the plurality of parallel conductive lines oriented in the second direction (e.g., 520 of FIG. 5 or FIG. 6) may have a line width in a range between approximately 5 micrometers and approximately 10 micrometers. In still other embodiments, one or more of the plurality of parallel conductive lines oriented in the first direction (e.g., 510 of FIG. 5 or FIG. 6) and one or more of the plurality of parallel conductive lines oriented in the second direction (e.g., 520 of FIG. 5 or FIG. 6) may have a line width in a range between approximately 10 micrometers and approximately 50 micrometers. In still other embodiments, one or more of the plurality of parallel conductive lines oriented in the first direction (e.g., 510 of FIG. 5 or FIG. 6) and one or more of the plurality of parallel conductive lines oriented in the second direction (e.g., 520 of FIG. 5 or FIG. 6) may have a line width greater than approximately 50 micrometers. One of ordinary skill in the art will recognize that the shape and width of one or more of the plurality of parallel conductive lines oriented in the first direction (e.g., 510 of FIG. 5 or FIG. 6) and one or more of the plurality of parallel conductive lines oriented in the second direction (e.g., 520 of FIG. 5 or FIG. 6) may vary based on an application or a design in accordance with one or more embodiments of the present invention.

In certain embodiments, one or more of the plurality of channel pads (e.g., 540 of FIG. 5 or FIG. 6), one or more of the plurality of interconnect conductive lines (e.g., 550 of FIG. 5 or FIG. 6), and/or one or more of the plurality of interface connectors (e.g., 560 of FIG. 5 or FIG. 6) may have a different width or orientation. In addition, the number of channel pads (e.g., 540 of FIG. 5 or FIG. 6), interconnect conductive lines (e.g., 550 of FIG. 5 or FIG. 6), and/or interface connectors (e.g., 560 of FIG. 5 or FIG. 6) and the line-to-line spacing between them may vary based on an application or a design. One of ordinary skill in the art will recognize that the size, configuration, and design of each channel pad (e.g., 540 of FIG. 5 or FIG. 6), interconnect conductive line (e.g., 550 of FIG. 5 or FIG. 6), and/or interface connector (e.g., 560 of FIG. 5 or FIG. 6) may vary based on an application or a design in accordance with one or more embodiments of the present invention.

In typical applications, each of the one or more channel pads (e.g., 540 of FIG. 5 and FIG. 6), interconnect conductive lines (e.g., 550 of FIG. 5 and FIG. 6), and/or interface connectors (e.g., 560 of FIG. 5 and FIG. 6) have a width substantially larger than each of the plurality of parallel conductive lines oriented in a first direction (e.g., 510 of FIG. 5 or FIG. 6) or each of the plurality of parallel conductive lines oriented in a second direction (e.g., 520 of FIG. 5 or FIG. 6). One of ordinary skill in the art will recognize that the size, configuration, and design as well as the number, shape, and width of channel pads (e.g., 540 of FIG. 5 or FIG. 6), interconnect conductive lines (e.g., 550 of FIG. 5 or FIG. 6), and/or interface connectors (e.g., 560 of FIG. 5 or FIG. 6) may vary based on an application or a design in accordance with one or more embodiments of the present invention.

FIG. 8 shows a flexographic printing station 800 in accordance with one or more embodiments of the present invention. Flexographic printing station 800 may include an ink pan 810, an ink roll 820 (also referred to as a fountain roll), an anilox roll 830 (also referred to as a meter roll), a doctor blade 840, a printing plate cylinder 850, a flexographic printing plate 860, and an impression cylinder 870 configured to print on a transparent substrate 410 material that moves through the station 800.

In operation, ink roll 820 rotates transferring ink 880 from ink pan 810 to anilox roll 930. Anilox roll 830 may be constructed of a rigid cylinder that includes a curved contact surface about the body of the cylinder that contains a plurality of dimples, also referred to as cells (not shown), that hold and transfer ink 880. As anilox roll 830 rotates, doctor blade 840 may be used to remove excess ink 880 from anilox roll 830. In transfer area 890, anilox roll 830 rotates transferring ink 880 from some of the cells to flexographic printing plate 860. Flexographic printing plate 860 may include a contact surface formed by distal ends of an image formed in flexographic printing plate 860. The distal ends of the image are inked to transfer an ink 880 image, such as, for example, at least a portion of an image of a conductive pattern, to transparent substrate 410. The cells may meter the amount of ink 880 transferred to flexographic printing plate 860 to a uniform thickness. In certain embodiments, ink 880 may be a precursor, or catalytic, ink that serves as a plating seed suitable for metallization by electroless plating or other buildup processes. For example, ink 880 may be a catalytic ink that comprises one or more of silver, nickel, copper, palladium, cobalt, platinum group metals, alloys thereof, or other catalytic particles. In other embodiments, ink 880 may be any other precursor ink. In still other embodiments, ink 880 may be a conductive ink. One of ordinary skill in the art will recognize that the composition of ink 880 may vary based on an application or a design.

Printing plate cylinder 850 may be constructed of a rigid cylinder composed of a metal, such as, for example, steel. Flexographic printing plate 860 may be mounted to printing plate cylinder 850 by an adhesive (not shown). The transparent substrate 410 material moves between the counter rotating flexographic printing plate 860 and impression cylinder 870. Impression cylinder 870 may be constructed of a rigid cylinder composed of a metal that may be coated with an abrasion resistant coating. As impression cylinder 870 rotates, it applies pressure between transparent substrate 410 material and flexographic printing plate 860, transferring an ink 880 image from flexographic printing plate 860 onto transparent substrate 410 at transfer area 895. The rotational speed of printing plate cylinder 850 is synchronized to match the speed at which transparent substrate 410 material moves through flexographic printing system 800. The speed may vary between 20 feet per minute to 750 feet per minute.

In certain embodiments, one or more flexographic printing stations 800 may be used to print a precursor, or catalytic, ink 880 image (not shown) of one or more conductive patterns (e.g., first conductive pattern 420 or second conductive pattern 430) on one or more sides of one or more transparent substrates 410. Subsequent to flexographic printing, the precursor, or catalytic, ink 880 image (not shown) may be metallized by one or more of an electroless plating process, an immersion bathing process, and/or other buildup processes, forming one or more conductive patterns (e.g., first conductive pattern 420 or second conductive pattern 430) on one or more sides of one or more transparent substrates 410. In other embodiments, one or more flexographic printing stations 800 may be used to print one or more conductive patterns (e.g., first conductive pattern 420 or second conductive pattern 430) on one or more sides of one or more transparent substrates 410 by directly printing the conductive patterns with a conductive ink 880.

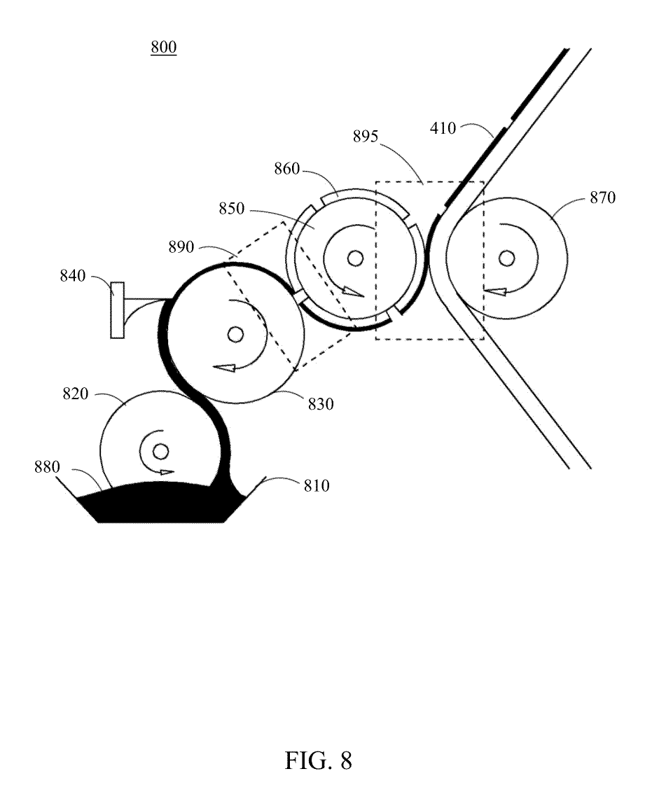

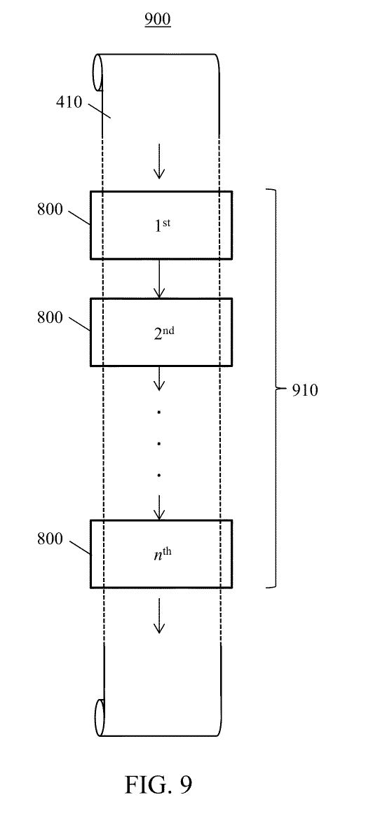

FIG. 9 shows a multi-station flexographic printing system 900 in accordance with one or more embodiments of the present invention. In certain embodiments, a multi-station flexographic printing system 900 may include a plurality 910 of flexographic printing stations 800 that are configured to print on one or more sides of a transparent substrate 410 in sequential order. In applications where the multi-station flexographic printing system 900 is configured to print on opposing sides of the same transparent substrate 410, one or more flexographic printing stations 800 of the plurality 910 of flexographic printing stations 800 may be configured to print on a first side of transparent substrate 410 and one or more flexographic printing stations 800 of the plurality 910 of flexographic printing stations 800 may be configured to print on a second side of transparent substrate 410. In other embodiments, a multi-station flexographic printing system 900 may include a plurality 910 of flexographic printing stations 800 where only a subset of the plurality 910 of flexographic printing stations 800 are configured to print on one or more sides of a transparent substrate 410 in sequential order. One of ordinary skill in the art will recognize that the configuration of multi-station flexographic printing system 900 may vary based on an application or design in accordance with one or more embodiments of the present invention.

Multi-station flexographic printing system 900 includes a plurality 910 of flexographic printing stations 800. The plurality 910 of flexographic printing stations 800 may include a number, n, of flexographic printing stations 800 where the number may vary based on an application or design. For example, in certain embodiments, a first flexographic printing station (1^{st} 800 of FIG. 9) may be used to print a non-catalytic ink (880 of FIG. 8) image on substrate 410 in an area outside an area reserved for an image of, for example, one or more conductive patterns. The first flexographic printing station may print, for example, one or more bearer bars (not shown) and/or one or more registration marks (not shown) that may be used to align multi-station flexographic printing system 900.

The number, n−1, of subsequent flexographic printing stations (2^{nd} through n^{th} 800 of FIG. 9) may vary based on an application or design. In certain embodiments, the number of subsequent flexographic printing stations 800 may include at least one flexographic printing station 800 for each side of transparent substrate 410 to be printed. In other embodiments, the number of subsequent flexographic printing stations 800 may include a plurality of flexographic printing stations 800 for each side of transparent substrate 410 to be printed. In still other embodiments, the number of subsequent flexographic printing stations 800 may include a plurality of flexographic printing stations 800 for each side of transparent substrate 410 to be printed, where the number of flexographic printing stations 800 for a given side may be determined by the number of micrometer-fine lines or features to be printed having a different width and/or orientation.

For example, in certain touch sensor embodiments, multi-station flexographic printing system 900 may be configured to print an image of a first conductive pattern (e.g., first conductive pattern 420) on a first side of transparent substrate 410 and an image of a second conductive pattern (e.g., second conductive pattern 430) on a second side of transparent substrate 410. The image of the first conductive pattern may include an image of a plurality of parallel conductive lines oriented in a first direction (e.g., 510 of FIG. 5), an image of a plurality of parallel conductive lines oriented in a second direction (e.g., 520 of FIG. 5), and an image of bezel circuitry (e.g., 540, 550, and 560 of FIG. 5). The image of the second conductive pattern may include an image of a plurality of parallel conductive lines oriented in a first direction (e.g., 510 of FIG. 6), an image of a plurality of parallel conductive lines oriented in a second direction (e.g., 520 of FIG. 6), and an image of bezel circuitry (e.g., 540, 550, and 560 of FIG. 6).

Continuing with the example, a first flexographic printing station (1^{st} 800 of FIG. 9) may be configured to print a non-catalytic ink (880 of FIG. 8) image on a first side of transparent substrate 410, a second flexographic printing station (2^{nd} 800 of FIG. 9), a third flexographic printing station (3^{rd} 800 of FIG. 9), and a fourth flexographic printing station (4^{th} 800 of FIG. 9) may be configured to print a catalytic ink (880 of FIG. 8) image of a first conductive pattern (e.g., first conductive pattern 420) on the first side of transparent substrate 410, and a fifth flexographic printing station (5^{th} 800 of FIG. 9), a sixth flexographic printing station (6^{th} 800 of FIG. 9), and a seventh flexographic printing station (7^{th} 800 of FIG. 9) may be configured to print a catalytic ink (880 of FIG. 8) image of a second conductive pattern (e.g., second conductive pattern 430) on a second side of transparent substrate 410. One of ordinary skill in the art will recognize that the number and configuration of flexographic printing stations 800 of a multi-station flexographic printing system 900 may vary based on an application or design in accordance with one or more embodiments of the present invention.

In embodiments where a plurality 910 of flexographic printing stations 800 are used as part of a multi-station flexographic printing system 900, such as, for example, printed touch sensor applications, alignment of one or more of the flexographic printing stations 800 of the plurality 910 of flexographic printing stations 800 may be critically important to ensure proper operation of the touch sensor.

FIG. 10A shows a Moiré interference pattern 1000 in accordance with one or more embodiments of the present invention. In certain embodiments, Moiré interference pattern 1000 may be formed in a flexographic printing plate (e.g., 860 of FIG. 8) that is used to print an ink (e.g., 880 of FIG. 8) image of Moiré interference pattern 1000 on a transparent substrate (e.g., 410 of FIG. 9) during flexographic printing operations. Moiré interference pattern 1000 may be formed in a flexographic printing plate (e.g., 860 of FIG. 8) using the same process used to form the image of one or more conductive patterns in the flexographic printing plate. For example, a desired pattern may be drawn in a software application, such as a computer-aided drafting (“CAD”) software application. The desired pattern may be laser-ablated into a thermal imaging layer (not shown). The thermal imaging layer may include a PET base layer (not shown) covered by a laser-ablation coating layer (not shown). The laser-ablation process ablates portions of the laser-ablation coating layer in a pattern corresponding to the desired pattern, but the ablation does not extend into the PET layer. After laser-ablation, the thermal imaging layer includes the PET base layer and remaining portions of the laser-ablation coating layer, where the exposed portions of the PET base layer correspond to the desired pattern. The thermal imaging layer may then be laminated to a flexographic printing plate substrate (not shown). The flexographic printing plate substrate may include a PET base layer (not shown) covered by a photopolymer layer (not shown). The laser-ablation coating layer side of the thermal imaging layer may be laminated to a top, or photopolymer layer, side of the flexographic printing plate substrate. The flexographic printing plate substrate may then be exposed to ultraviolet (“UV”) radiation to crosslink and polymerize the desired pattern into the photopolymer layer of the flexographic printing plate substrate. After UV exposure, the thermal imaging layer may be removed from the flexographic printing plate substrate and the flexographic printing plate substrate may be developed. Conventional flexographic printing plate substrate materials are negatively photo-reactive when exposed to UV radiation. Thus, the UV exposed portions of the photopolymer layer remain on the PET base layer after development, forming the distal ends of the image of the desired pattern that are used to print, while the unexposed portions of the photopolymer layer are removed by the developer.

Turning to the design of an interference pattern, in certain embodiments, Moiré interference pattern 1000 may comprise a plurality of concentric rings 1010, where there is a contrast between each concentric ring and the space on either side of a given concentric ring. The plurality of concentric rings 1010 may be drawn in the CAD software application using, for example, the following process. A maximum radius, MR, for the desired Moiré interference pattern 1000 may be selected. A pitch width, PW, for measurement accuracy may be selected. A maximum number of concentric rings, MN, may be calculated by dividing the maximum radius, MR, by the quantity two times the pitch width, PW, (MN=MR/(2×PW)). This is due to two inverted Moiré interference patterns that will later be overlapped. The maximum displacement error, MDE, detectable with the selected Moiré interference patterns may be bounded by the product of the maximum number of concentric rings, MN, and the pitch width, PW, (MDE=MN×PW). A trace width, TW, for the concentric rings is equal to or slightly larger than the pitch width, PW, (TW>=PW). A space width, SW, between adjacent concentric circles may be selected. The space width, SW, should be equal to the trace width, TW, if the trace width equals the pitch width, (SW=TW if TW=PW). If the trace width, TW, is larger than the pitch width, PW, the space width, SW, should be recalculated so that the space width, SW, equals the quantity [(2×PW)−TW]. The reason for the trace width, TW, to be slightly larger than the space width, SW, is because, when Moiré interference pattern 1000 is center aligned with the inverted Moiré interference pattern 1020, the trace width, TW, rings from each Moiré pattern will completely cover the space width, SW, of the other as described below in more detail.

The plurality of concentric rings 1010 having the calculated trace width, TW, and selected space width, SW, may be drawn in a CAD software application using the following process. Draw a first ring with trace width, TW, which corresponds to raised portions of a flexographic printing plate configured to print, with an outside radius equal to the maximum radius, MR. Draw a second ring with trace width, TW, which corresponds to the raised portions of the flexographic printing plate configured to print, with an outside radius equal to the difference between the first ring's inside radius and the space width, SW, a space between raised portions of the flexographic printing plate that do not print. Draw a third ring with trace width, TW, which corresponds to raised portions of the flexographic printing plate configured to print, with an outside radius equal to the difference between the second ring's inside radius and the space width, SW, a space between raised portions of the flexographic printing plate that do not print. Draw a fourth ring with trace width, TW, which corresponds to raised portions of the flexographic printing plate configured to print, with an outside radius equal to the difference between the third ring's inside radius and the space width, SW, a space between raised portions of the flexographic printing plate that do not print. This process may be continued until the calculated radius is less than the trace width, TW.

In other embodiments, Moiré interference pattern 1000 may be drawn in the CAD software application using overlapping filled circles (not shown). For example, the first circle, having the maximum radius, MR, may be drawn as a dark, or high contrast, filled circle. The second circle, having a radius equal to the difference between the maximum radius, MR, and the trace width, TW, may be drawn as a light, or low contrast, filled circle and placed on top of the first circle. The third circle, having a radius equal to the difference between the second circle's radius and the space width, SW, may be drawn as a dark filled circle and placed on top of the second circle. The fourth circle, having a radius equal to the difference between the third circle's radius and the trace width, TW, may be drawn as a light filed circle and placed on top of the third circle. In this way, the dark filled first circle, the light filled second circle, the dark filled third circle, and the light filled fourth circle form two concentric rings. This process may be repeated until the calculated radius is less than the trace width, TW.

In still other embodiments, Moiré interference pattern 1000 may be drawn in the CAD software application by placing a plurality of concentric rings (not shown) that share the same center, where the plurality of concentric rings are each spaced out from the previous ring alternately by increasing the radius by the trace width, TW, or the space width, SW. The space between the first and second concentric rings, the third and fourth concentric rings, the fifth and sixth concentric rings, etc. forms a plurality of concentric rings 1010 that correspond to raised portions of a flexographic printing plate configured to print. The space between the second and third concentric rings, the fourth and the fifth concentric rings, the sixth and the seventh concentric rings, etc. forms the spaces between the plurality of concentric rings 1010 that correspond to the spaces between the raised portions of the flexographic printing plate and do not print.

In still other embodiments, Moiré interference pattern 1000 may be drawn in the CAD software application using any other technique (not shown) that ensures that an image of the plurality of concentric rings 1010 are printed on substrate and the space between the plurality of concentric rings is not printed. The trace width, TW, for both Moiré interference pattern 1000 and inverted Moiré interference pattern 1020, should have the same width. The space width, SW, for both Moiré interference pattern 1000 and inverted Moiré interference pattern 1020, should have the same width. The reason for having a trace width, TW, slightly larger than the space width, SW, is so when Moiré interference pattern 1000 is center aligned with inverted Moiré interference pattern 1020, the trace width, TW, rings from each Moiré pattern will completely cover the space width, SW, of the other as described below in more detail. In this way, when Moiré interference pattern 1000 perfectly overlaps an inverted image of itself, the resulting image is an opaque circle on substrate.

One of ordinary skill in the art will recognize that any other pattern suitable for generating Moiré interference may be used in accordance with one or more embodiments of the present invention. One of ordinary skill in the art will also recognize that the type, shape, pattern, and size of the Moiré interference pattern used may vary based on an application or design in accordance with one or more embodiments of the present invention.

FIG. 10B shows an inverted Moiré interference pattern 1020 in accordance with one or more embodiments of the present invention. In certain embodiments, an image of inverted Moiré interference pattern 1020 may be formed in a flexographic printing plate (e.g., 860 of FIG. 8) using the same process used to form the image of one or more conductive patterns in the flexographic printing plate, including the process discussed in detail above. Inverted Moiré interference pattern 1020 may be an inverted image of the corresponding Moiré interference pattern 1000 used. For example, a plurality of concentric rings 1030 of inverted Moiré interference pattern 1020 correspond to the spaces, or non-patterned areas, between the plurality of concentric rings 1010 of Moiré interference pattern 1000.

One of ordinary skill in the art will recognize that any pattern suitable for generating Moiré interference may be used in accordance with one or more embodiments of the present invention. One of ordinary skill in the art will also recognize that the type, shape, pattern, and size of the inverted Moiré interference pattern used may vary based on an application or design in accordance with one or more embodiments of the present invention.

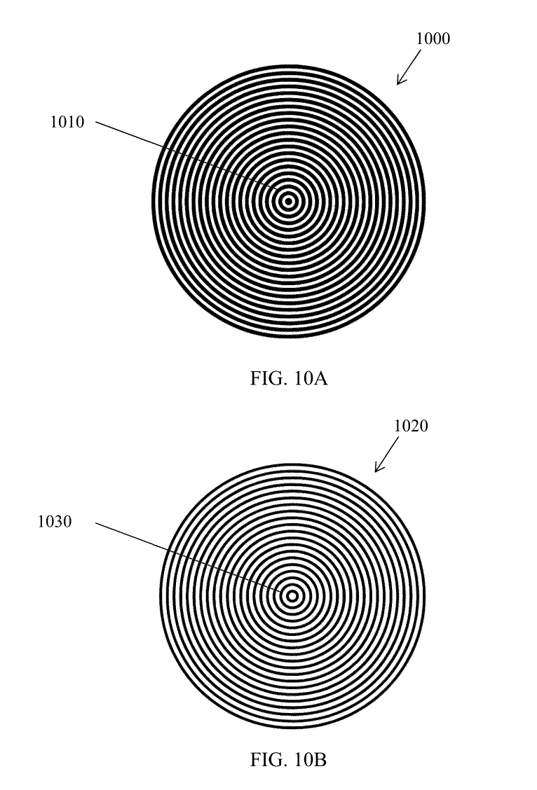

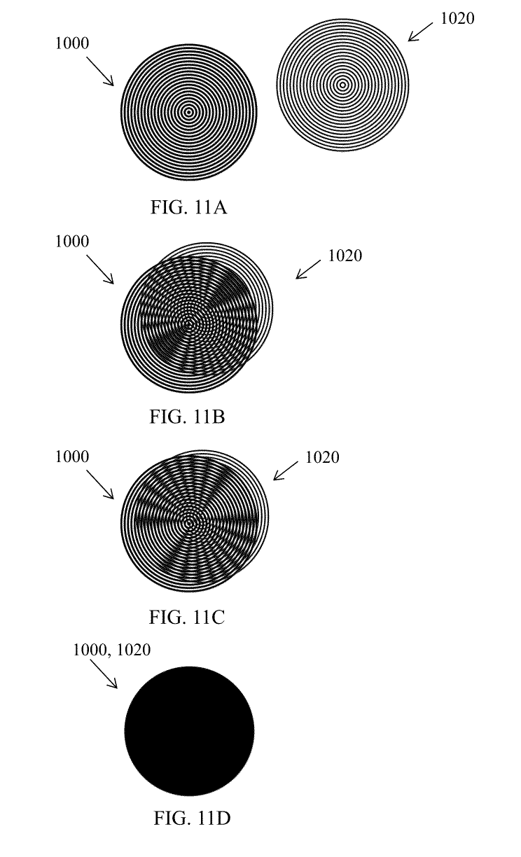

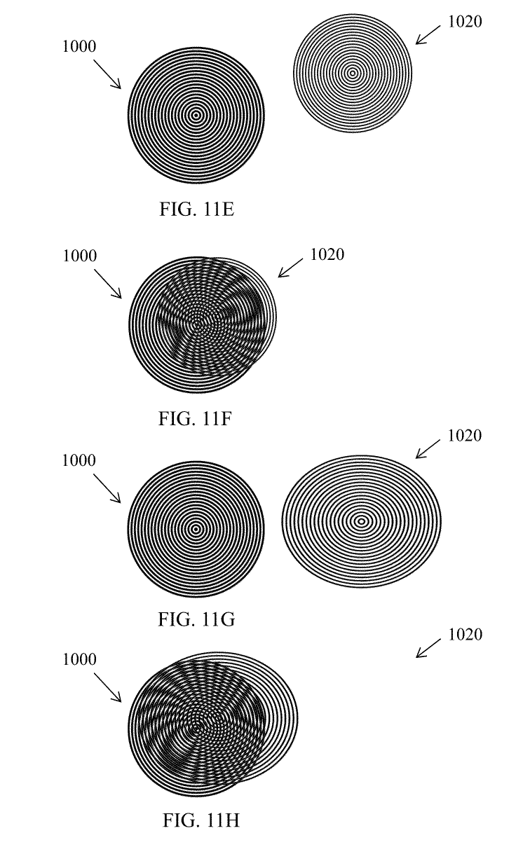

FIG. 11A shows a Moiré interference pattern 1000 and an inverted Moiré interference pattern 1020 that do not overlap in accordance with one or more embodiments of the present invention. Moiré interference pattern 1000 may be printed, for example, on a side of a first transparent substrate (not independently illustrated) and inverted Moiré interference pattern 1020 may be printed, for example, on the same or opposing side of the first transparent substrate or on a side of a second transparent substrate (not independently illustrated) that is aligned to the first transparent substrate. The appearance, or lack thereof, of Moiré interference generated by Moiré interference pattern 1000 and inverted Moiré interference pattern 1020 may be used as an indicator of alignment.

FIG. 11B shows an inverted Moiré interference pattern 1020 that partially overlaps a Moiré interference pattern 1000 in accordance with one or more embodiments of the present invention. However, a center of inverted Moiré interference pattern 1020 is not aligned to a center of Moiré interference pattern 1000. Because they are not center aligned, Moiré interference may be visually apparent. One of ordinary skill in the art will recognize that Moiré interference is the perception of one or more patterns, caused by overlapping images, which are not part of the images themselves. In this instance, the Moiré interference creates the perception of vectors that radiate out from the centers of the respective overlapping patterns 1000 and 1020 or from the midpoint between the centers of the overlapping patterns 1000 and 1020. The vectors may be used for further alignment manually or by computer in applications that use automation. Moiré interference may be used in this manner to provide a visual indication of alignment accuracy between Moiré interference pattern 1000 and inverted Moiré interference pattern 1020 and, by extension, of their respective flexographic printing stations (800 of FIG. 9) that printed the patterns. The Moiré interference generated indicates that the center of inverted Moiré interference pattern 1020 is not aligned to the center of Moiré interference pattern 1000.

FIG. 11C shows an inverted Moiré interference pattern 1020 that substantially overlaps a Moiré interference pattern 1000 in accordance with one or more embodiments of the present invention. While closer to alignment, the center of inverted Moiré interference pattern 1020 is still not aligned to the center of Moiré interference pattern 1000. The substantial overlap of inverted Moiré interference pattern 1020 and Moiré interference pattern 1000 generates Moiré interference that may be visually apparent. In this instance, the Moiré interference creates the perception of vectors that radiate out from the midpoint between the centers of the overlapping patterns 1000 and 1020. The vectors may be used for further alignment manually or by computer in applications that use automation. Moiré interference may be used in this manner to provide a visual indication of alignment accuracy between Moiré interference pattern 1000 and inverted Moiré interference pattern 1020 and, by extension, of their respective flexographic printing stations (800 of FIG. 9) that printed the patterns. The Moiré interference generated indicates that the center of inverted Moiré interference pattern 1020 is not aligned to the center of Moiré interference pattern 1000.

FIG. 11D shows an inverted Moiré interference pattern 1020 that overlaps and is center-aligned to a Moiré interference pattern 1000 in accordance with one or more embodiments of the present invention. Because the center of inverted Moiré interference pattern 1020 is aligned to the center of Moiré interference pattern 1000, the combination of overlapping Moiré interference pattern 1000 and inverted Moiré interference pattern 1020 form an opaque circle that does not exhibit Moiré interference. The lack of Moiré interference may be used in this manner to provide a visual indication of alignment accuracy between Moiré interference pattern 1000 and inverted Moiré interference pattern 1020 and, by extension, of their respective flexographic printing stations (800 of FIG. 9). The lack of Moiré interference indicates that inverted Moiré interference pattern 1020 overlaps and is center-aligned to Moiré interference pattern 1000. By extension, their respective flexographic printing stations (800 of FIG. 9) are aligned.

In certain circumstances, the flexographic printing process may print an ink image of Moiré interference pattern 1000 and/or inverted Moiré interference pattern 1020 on substrate that does not match what is intended because of issues that may arise during flexographic printing operations. For example, FIG. 11E shows a Moiré interference pattern 1000 printed on substrate as expected and an inverted Moiré interference pattern 1020 that is printed on substrate with altered dimensions. In this example, inverted Moiré interference pattern 1020 appears to be shrunken dimensionally, which may indicate an issue with its respective flexographic printing plate that may have occurred during the flexographic printing plate fabrication process. While the pattern is shown shrunken, one of ordinary skill in the art will recognize that the following also applies in cases where the pattern is enlarged. Continuing in FIG. 11F, a center of inverted Moiré interference pattern 1020 is not aligned to a center of Moiré interference pattern 1000. Because they are not center aligned, Moiré interference may be visually apparent. Because inverted Moiré interference pattern 1020 is shrunken, the Moiré interference creates the perception of curved or circular vectors that radiate out, versus the straight line vectors formed when both images are the same size. Moiré interference may be used in this manner to provide a visual indication as to an issue with the dimensional aspects of one or more flexographic printing plates. The curved or circular vectors indicate that at least one of the Moiré interference patterns, and their respective flexographic printing plate, may have an issue that requires attention.

Similarly, FIG. 11G shows a Moiré interference pattern 1000 be printed on substrate as expected and an inverted Moiré interference pattern 1020 that is printed on substrate with altered dimensions. In this example, inverted Moiré interference pattern 1020 appears elongated along one axis, which may indicate an issue with its respective flexographic printing plate or with its respective flexographic printing station. While the pattern is shown elongated along one axis, one of ordinary skill in the art will recognize that the following also applies in cases where the pattern is shrunken along one axis. Continuing in FIG. 11H, a center of inverted Moiré interference pattern 1020 is not aligned to a center of Moiré interference pattern 1000. Because they are not center aligned, Moiré interference may be visually apparent. Because inverted Moiré interference pattern 1020 is elongated along one axis, the Moiré interference creates the perception of non-uniform vectors and curves that radiate out. Moiré interference may be used in this manner to provide a visual indication as to an issue with the dimensional aspects of one or more flexographic printing plates. The curved or circular vectors indicate that at least one of the Moiré interference patterns and their respective flexographic printing plate or their respective flexographic printing station may have an issue that requires attention.

With respect to FIGS. 11A through 11H, one of ordinary skill in the art will recognize that the role of Moiré interference pattern 1000 and inverted Moiré interference pattern 1020 may be reversed in accordance with one or more embodiments of the present invention.

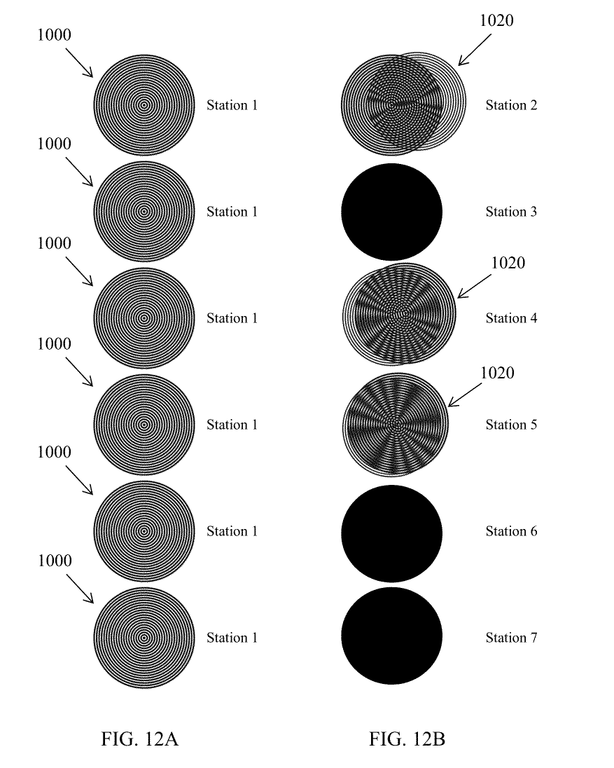

FIG. 12A shows a plurality of Moiré interference patterns 1000 disposed on a transparent substrate (e.g., transparent substrate 410) in accordance with one or more embodiments of the present invention. In certain embodiments, where a plurality of flexographic printing stations (800 of FIG. 9) are used to print one or more conductive patterns (or a precursor, or catalytic, ink image of the one or more conductive patterns) on one or more sides of one or more transparent substrates (e.g., transparent substrate 410), one or more Moiré interference patterns 1000 may be printed on the transparent substrate to assist in the alignment of the stations (910 of FIG. 9).

In certain embodiments, where a plurality of flexographic printing stations (910 of FIG. 9) are used to print the one or more conductive patterns (or a precursor, or catalytic, ink image of the one or more conductive patterns) on one or more sides of one or more transparent substrates, a first flexographic printing station (e.g., 1^{st} 800 of FIG. 9) may print one or more Moiré interference patterns 1000 on a first side of a first transparent substrate. The first flexographic printing station may print at least one Moiré interference pattern 1000 on the first side of the first transparent substrate for each of the one or more subsequent flexographic printing stations (e.g., 2^{nd} through n^{th} 800 of FIG. 9) to be aligned. In embodiments where a plurality of Moiré interference patterns 1000 are printed on the first side of the first transparent substrate, each Moiré interference pattern 1000 may be printed in a unique location allocated for each of the one or more subsequent flexographic printing stations to print their corresponding inverted Moiré interference pattern (not shown).

Continuing in FIG. 12B, each of the one or more subsequent flexographic printing stations to be aligned may print at least one inverted Moiré interference pattern 1020 on the first side or a second side of the first transparent and/or on a side of a second transparent substrate. The at least one inverted Moiré interference pattern 1020 may be printed in the unique location allocated to that flexographic printing station, center-aligned to that station's corresponding Moiré interference pattern 1000 printed by the first flexographic printing station. In this way, if one or more of the subsequent flexographic printing stations are out of alignment, one or more inverted Moiré interference patterns 1020 are not center aligned with their corresponding Moiré interference pattern 1000, producing visible Moiré interference as an indicator of misalignment. Consequently, Moiré interference may be used as a visual indication as to which flexographic printing station or stations are out of alignment and correction can be made to ensure alignment of one or more flexographic printing stations (e.g., 800 of FIG. 9) of a multi-station flexographic printing system (e.g., 900 of FIG. 9). One of ordinary skill in the art will recognize that other processes may be used instead of flexographic printing in a similar manner in accordance with one or more embodiments of the present invention. Moiré interference patterns may be disposed on substrate using any other process suitable for disposing non-conductive or conductive patterns on substrate. Moreover, one of ordinary skill in the art will also recognize that the role of Moiré interference pattern 1000 and inverted Moiré interference pattern 1020 may be reversed in accordance with one or more embodiments of the present invention.

In certain embodiments, for example, seven flexographic printing stations (e.g., 800 of FIG. 9) may be used as part of a multi-station flexographic printing system (e.g., 900 of FIG. 9) that is configured to print on both sides of a transparent substrate (e.g., transparent substrate 410) as part of a method of fabricating a touch sensor. Flexographic printing stations two through four may print on a first side of a transparent substrate and flexographic printing stations five through seven may print on a second side of the transparent substrate. The first flexographic printing station (e.g., 1^{st} 800 of FIG. 9) may print, for example, six Moiré interference patterns 1000 on the first side of the transparent substrate (as depicted in FIG. 12A), one for each subsequent flexographic printing station, each printed in a unique location allocated for a given subsequent flexographic printing station. The second (e.g., 2^{nd} 800 of FIG. 9), third (e.g., 3^{rd} 800 of FIG. 9), and fourth (e.g., 4^{th} 800 of FIG. 9) flexographic printing stations may each print an inverted Moiré interference pattern 1020 on the first side of the transparent substrate (as depicted in FIG. 12B) in their respective allocated locations, center aligned by design (but not necessarily in practice) with their corresponding Moiré interference patterns 1000. The fifth (e.g., 5^{th} 800 of FIG. 9), sixth (e.g., 6^{th} 800 of FIG. 9), and seventh (e.g., 7^{th} 800 of FIG. 9) flexographic printing stations may each print an inverted Moiré interference pattern 1020 on the second side of the transparent substrate (as depicted in FIG. 12B) in their respective allocated locations, center aligned by design (but not necessarily in practice) with their corresponding Moiré interference patterns 1000. As depicted in FIG. 12B, inverted Moiré interference patterns 1020 printed by stations two, four, and five are not center aligned with their corresponding Moiré interference patterns 1000, producing visible Moiré interference as an indicator of misalignment.

As such, there is an optical indication that stations one, three, six, and seven are aligned and stations two, four, and five require further alignment in relationship to station one. In certain embodiments, manual action may be taken to correct the one or more misalignments. In other embodiments, automation or automation assistance may be used to correct the one or more misalignments. With a camera inspection system, the overlapping Moiré interference patterns disposed on substrate may be positioned between a camera and a bright solid background. The background color and the illumination may be selected to ensure the greatest contrast between dark and light. The Moiré interference may be blob isolated to extract density and a vector direction to correct the misalignment. This in turn can trigger, for example, a flexographic printing press to correct a flexographic printing plate position of a given flexographic printing station to correct the misalignment. In automated embodiments, a servo or stepper motor may be used to adjust the controls of the flexographic printing press. In manual embodiments, a human operator may adjust the controls of the flexographic printing press.

Notwithstanding the example, one of ordinary skill in the art will recognize that a flexographic printing system, comprised of any number of flexographic printing stations, configured to print anything suitable for printing by flexography, may use the same process in accordance with one or more embodiments of the present invention to ensure alignment.

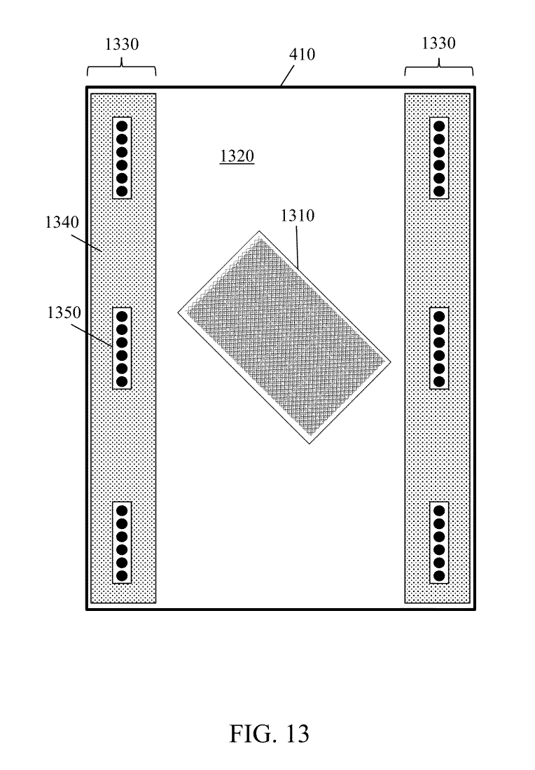

FIG. 13 shows a printed transparent substrate in accordance with one or more embodiments of the present invention. Printed transparent substrate 410 may include a printed image area 1310, a non-printed image area 1320, and at least one bearer bar/registration mark area 1330. The printed image area 1310 may include a printed image, for example, an image of at least a part of a conductive pattern. The non-printed image area 1320 may include the area other than the printed image area 1310. At least a portion of the non-printed image area 1320 may be allocated to at least one bearer bar/registration mark area 1330. Bearer bar/registration mark area 1330 is an area outside of the printed image area 1310 reserved for at least one printed bearer bar 1340 and at least one registration mark, such as, for example, a printed set 1350 of at least one Moiré interference pattern (e.g., 1000 of FIG. 10) and at least one corresponding inverted Moiré interference pattern (e.g., 1020 of FIG. 10).

In embodiments using multiple flexographic printing stations (e.g., 900 of FIG. 9), each station's flexographic printing plate (e.g., 860 of FIG. 8) may include an image of at least a part of a conductive pattern, at least one bearer bar (not independently illustrated), and/or at least one registration mark (not independently illustrated). The at least one bearer bar may be used to ensure the appropriate amount of pressure is applied between an impression cylinder (e.g., 870 of FIG. 8) and a flexographic printing plate such that the flexographic printing plate transfers a suitable amount of ink or other material to substrate during flexographic printing operations. Subsequent to flexographic printing, at least one printed bearer bar 1340 may be visible in the bearer bar/registration mark area 1330 on substrate 410.

In embodiments using multiple flexographic printing stations, each station's flexographic printing plate may include an image of at least one Moiré interference pattern or inverted Moiré interference pattern. A first flexographic printing station may print at least one Moiré interference pattern for each of the subsequent flexographic printing stations as part of the flexographic printing system. Each of the subsequent flexographic printing stations may print at least one inverted Moiré interference pattern to provide an optical indicator of alignment between the multiple flexographic printing stations. Subsequent to flexographic printing, at last one set 1350 of at least one Moiré interference pattern and at least one inverted Moiré interference pattern may be visible in the bearer bar/registration mark area 1330 or other designated area on substrate 410. If there is no Moiré interference, the multiple flexographic printing stations are aligned to one another. If there is Moiré interference, there is an optical indicator of which station is out of alignment and the Moiré interference provides a visual clue as to how to correct the misalignment.

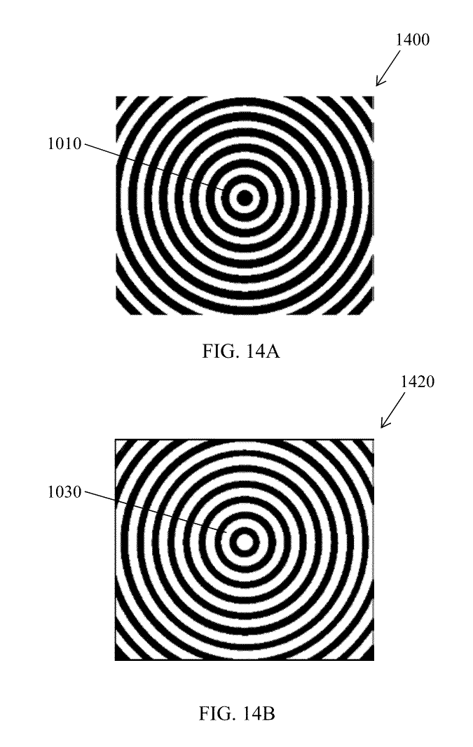

FIG. 14A shows a squared Moiré interference pattern 1400 in accordance with one or more embodiments of the present invention. In certain embodiments, squared Moiré interference pattern 1400 may be formed in a flexographic printing plate (e.g., 860 of FIG. 8) that is used to print an ink (880 of FIG. 8) image of squared Moiré interference pattern 1400 on a transparent substrate (e.g., 410 of FIG. 9) during flexographic printing operations. Squared Moiré interference pattern 1400 may be formed in a flexographic printing plate (e.g., 860 of FIG. 8) using the same process used to form the image of one or more conductive patterns in the flexographic printing plate. In certain embodiments, squared Moiré interference pattern 1400 may be a plurality of concentric rings 1010. The plurality of concentric rings 1010 may be constructed by the same processes discussed above with respect to FIG. 10A. Once the plurality of concentric rings 1010 are constructed, they may be boxed or squared off forming squared Moiré interference pattern 1400. This provides the Moiré interference of the plurality of concentric rings 1010, but provides a fixed rectangular size for the pattern that may assist the use of camera-based systems. One of ordinary skill in the art will recognize that any pattern suitable for generating Moiré interference may be used in accordance with one or more embodiments of the present invention. One of ordinary skill in the art will also recognize that the type, shape, pattern, and size of squared Moiré interference pattern 1400 may vary based on an application or design in accordance with one or more embodiments of the present invention.

FIG. 14B shows a squared inverted Moiré interference pattern 1420 in accordance with one or more embodiments of the present invention. In certain embodiments, squared inverted Moiré interference pattern 1420 may be formed in a flexographic printing plate (e.g., 860 of FIG. 8) that is used to print an ink (880 of FIG. 8) image of squared inverted Moiré interference pattern 1420 on a transparent substrate (e.g., 410 of FIG. 9) during flexographic printing operations. Squared inverted Moiré interference pattern 1420 may be disposed on a transparent substrate (e.g., transparent substrate 410) using the same process or processes used to dispose a conductive pattern (e.g., 420 or 430 of FIG. 7) on the transparent substrate (e.g., transparent substrate 410). Squared inverted Moiré interference pattern 1420 may be an inverted image of the corresponding squared Moiré interference pattern 1400. As such, a plurality of concentric rings 1030 of squared inverted Moiré interference pattern 1420 correspond to the spaces, or non-patterned areas, between the plurality of concentric rings 1010 of squared Moiré interference pattern 1400.

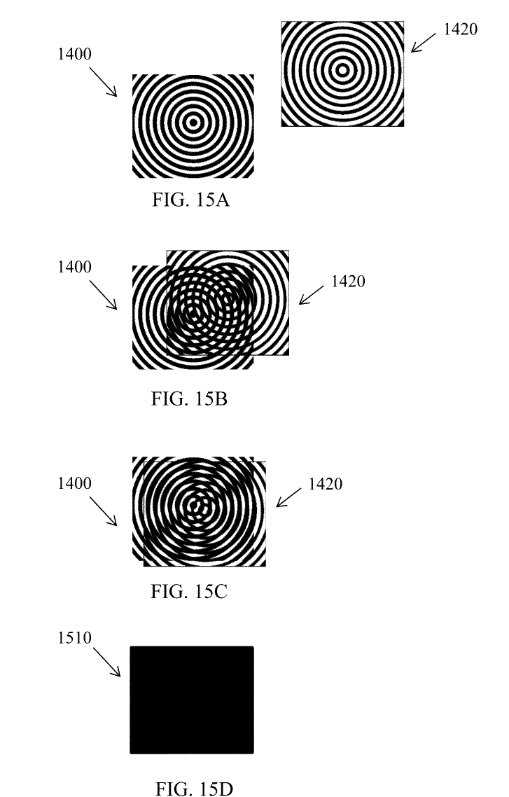

FIG. 15A shows a squared Moiré interference pattern 1400 and a squared inverted Moiré interference pattern 1420 that do not overlap in accordance with one or more embodiments of the present invention. Squared Moiré interference pattern 1400 may be disposed on a transparent substrate (e.g., transparent substrate 410) using the same process or processes used to dispose a conductive pattern (e.g., first conductive pattern 420 or second conductive pattern 430 of FIG. 7) on the transparent substrate (e.g., transparent substrate 410). In certain embodiments, squared Moiré interference pattern 1400 may be a plurality of concentric rings (e.g., 1010 of FIG. 10A) that are cropped to a predetermined shape. In the example depicted, the plurality of concentric rings are cropped to a rectangular or square shape. Squared Moiré interference pattern 1400 may be constructed using, for example, the same process set forth above with respect to FIG. 10A and then cropped according to a predetermined shape. Squared inverted Moiré interference pattern 1420 may be disposed on a transparent substrate (e.g., transparent substrate 410) using the same process or processes used to dispose a conductive pattern (e.g., first conductive pattern 420 or second conductive pattern 430 of FIG. 7) on the transparent substrate (e.g., transparent substrate 410). Squared inverted Moiré interference pattern 1420 may be an inverted image of the corresponding squared Moiré interference pattern 1400. One of ordinary skill in the art will recognize that any other shape(s) or pattern(s) capable of interfering may be used in accordance with one or more embodiments of the present invention.

FIG. 15B shows a squared Moiré interference pattern 1400 that partially overlaps a squared inverted Moiré interference 1420 pattern in accordance with one or more embodiments of the present invention. However, a center of squared inverted Moiré interference pattern 1420 is not aligned to a center of squared Moiré interference pattern 1400. Because squared inverted Moiré interference pattern 1420 is not center-aligned to squared Moiré interference pattern 1400, Moiré interference may be visually apparent. In this instance, the Moiré interference creates the perception of vectors that radiate out from the centers of the respective overlapping patterns 1400 and 1420 or from the midpoint between the centers of the overlapping patterns 1400 and 1420. The vectors may be used for further alignment manually or by computer in applications that use automation. In one or more embodiments of the present invention, Moiré interference may be used in this manner to provide a visual indication of alignment accuracy between squared Moiré interference pattern 1400 and squared inverted Moiré interference pattern 1420 and, by extension, of their respective flexographic printing stations (e.g., 800 of FIG. 9) that printed the patterns. The Moiré interference generated indicates that the center of squared inverted Moiré interference pattern 1420 is not aligned to the center of squared Moiré interference pattern 1400.

FIG. 15C shows a squared Moiré interference pattern 1400 that substantially overlaps a squared inverted Moiré interference pattern 1420 in accordance with one or more embodiments of the present invention. While closer to alignment, the center of squared inverted Moiré interference pattern 1420 is still not aligned to the center of squared Moiré interference pattern 1400. The substantial overlap of squared inverted Moiré interference pattern 1420 and squared Moiré interference pattern 1400 generates Moiré interference that may be visually apparent. In this instance, the Moiré interference creates the perception of vectors that radiate out from the midpoint between the centers of the overlapping patterns 1400 and 1420. The vector may be used for further alignment manually or by computer in applications that use automation. Moiré interference may be used in this manner to provide a visual indication of alignment accuracy between squared Moiré interference pattern 1400 and squared inverted Moiré interference pattern 1420 and, by extension, of their respective flexographic printing stations (e.g., 800 of FIG. 9) that printed the patterns. The Moiré interference generated indicates that the center of squared inverted Moiré interference pattern 1420 is not aligned to the center of squared Moiré interference pattern 1400.

FIG. 15D shows a squared Moiré interference pattern 1400 that overlaps and is center-aligned to a squared inverted Moiré interference pattern 1420 in accordance with one or more embodiments of the present invention. Because the center of squared inverted Moiré interference pattern 1420 is aligned to the center of squared Moiré interference pattern 1400, the combination of overlapping squared Moiré interference pattern 1400 and squared inverted Moiré interference pattern 1420 form an opaque rectangle or square 1510 that does not exhibit Moiré interference. The lack of Moiré interference may be used in this manner to provide a visual indication of alignment accuracy between squared Moiré interference pattern 1400 and squared inverted Moiré interference pattern 1420 and, by extension, of their respective flexographic printing stations (e.g., 800 of FIG. 9). The lack of Moiré interference indicates that squared inverted Moiré interference pattern 1420 overlaps and is center-aligned to squared Moiré interference pattern 1400. By extension, their respective flexographic printing stations (e.g., 800 of FIG. 9) are aligned.

With respect to FIGS. 15A through 15D, one of ordinary skill in the art will recognize that the role of squared Moiré interference pattern 1400 and squared inverted Moiré interference pattern 1420 may be reversed in accordance with one or more embodiments of the present invention. One of ordinary skill in the art will recognize that squared Moiré interference pattern 1400 and squared inverted Moiré interference pattern 1420 may be used in a similar manner to Moiré interference pattern 1000 and inverted Moiré interference pattern 1020. One of ordinary skill in the art will also recognize that other Moiré interference patterns and their inverted counterparts may be used in accordance with one or more embodiments of the present invention.

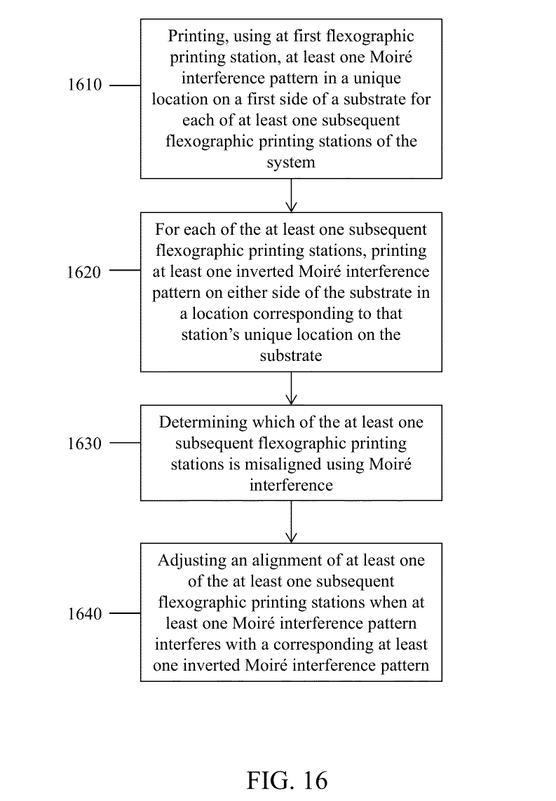

FIG. 16 shows a method of aligning a multi-station flexographic printing system using Moiré interference in accordance with one or more embodiments of the present invention. In one or more embodiments of the present invention, a plurality of flexographic printing stations may be used as part of a multi-station flexographic printing system. In certain embodiments, the multi-station flexographic printing system may be configured for use in the fabrication of touch sensors. In other embodiments, the multi-station flexographic printing system may be configured for use in any other application or design. One of ordinary skill in the art will recognize that the method of aligning a multi-station flexographic printing system using Moiré interference may be used in any multi-station flexographic printing application that requires alignment of one or more of the plurality of flexographic printing stations of the system.

In certain embodiments, a plurality of flexographic printing stations may be used as part of a multi-station flexographic printing system. Because of the roll-to-roll nature of the flexographic printing process, one or both sides of a substrate may be printed in sequence by the plurality of flexographic printing stations. In certain embodiments, the subsequent flexographic printing stations may be aligned relative to the first flexographic printing station. The number of subsequent flexographic printing stations may vary based on an application or design. If any one of the subsequent flexographic printing stations is misaligned, or outside of an application-specific alignment tolerance, the flexographic printing process may not yield product.

In certain embodiments, where the plurality of flexographic printing stations are used to fabricate a touch sensor having micrometer-fine lines or features, at least one of the flexographic printing stations may print an image of at least a portion of a conductive pattern on one or both sides of the substrate. In certain embodiments, the image of the at least portion of the conductive pattern may include an image of a plurality of conductive lines or features having a line width less than 5 micrometers. In other embodiments, the image of the at least portion of the conductive pattern may include an image of a plurality of conductive lines or features having a line width in a range between approximately 5 micrometers and approximately 10 micrometers. One of ordinary skill in the art will recognize that any other conductive pattern may be used in accordance with one or more embodiments of the present invention. In other embodiments, a plurality of flexographic printing stations may be used to print an image of a conductive pattern on one or both sides of the substrate. The printing of the image of the conductive pattern may be distributed among the plurality of flexographic printing stations.

Because the plurality of flexographic printing stations prints sequentially as part of the flexographic printing process, there may be a requirement for accurate and precise alignment between the flexographic printing stations. If the alignment is outside of an acceptable alignment tolerance, the touch sensor may not function. In certain embodiments, the alignment tolerance may be in a range between approximately 1 micrometer and approximately 4 micrometers. In other embodiments, the alignment tolerance may be in a range between approximately 4 micrometers and approximately 10 micrometers. In still other embodiments, the alignment tolerance may be in a range between approximately 10 micrometers and approximately 100 micrometers. One of ordinary skill in the art will recognize that, while the present method is advantageous in applications involving the flexographic printing of micrometer-fine lines or features, the method may be used in the same manner for applications that do not require as much precision in alignment.

In step 1610, a first flexographic printing station may be used to print at least one Moiré interference pattern in a unique location on a first side of a substrate for each of at least one subsequent flexographic printing stations of the system. In certain embodiments, each Moiré interference pattern may be a plurality of concentric rings. In other embodiments, each Moiré interference pattern may be a squared plurality of concentric rings. One of ordinary skill in the art will recognize that any other Moiré interference generating pattern may be used in accordance with one or more embodiments of the present invention. The first flexographic printing station may print at least one Moiré interference pattern for each of the subsequent stations in a unique location allocated to the respective station. For example, in certain embodiments, there may be six subsequent flexographic printing stations for a total of seven flexographic printing stations. The first flexographic printing station may print at least one Moiré interference pattern in a unique location on the substrate for each of the six subsequent flexographic printing stations.

In step 1620, each of the at least one subsequent flexographic printing stations may be used to print at least one inverted Moiré interference pattern on either side of the substrate in a location corresponding to that station's unique location on the substrate. In certain embodiments, each inverted Moiré interference pattern may be an inverse image of a Moiré interference pattern. In other embodiments, each inverted Moiré interference pattern may be a squared inverse image of a Moiré interference pattern. One of ordinary skill in the art will recognize that any other Moiré interference generating pattern may be used in accordance with one or more embodiments of the present invention. As such, each of the at least one subsequent flexographic printing stations prints at least one inverted Moiré interference pattern on either side of the substrate in a unique location allocated to that station, where each inverted Moiré interference pattern is intended to be center-aligned with its corresponding Moiré interference pattern printed by the first flexographic printing station.

In step 1630, a determination may be made as to which of the at least one subsequent flexographic printing stations is misaligned using Moiré interference. When a corresponding pair of at least one Moiré interference pattern and a corresponding at least one inverted Moiré interference pattern are center-aligned on substrate, the lack of Moiré interference indicates alignment between the given station (that printed the inverted Moiré interference pattern) and the first flexographic printing station (that printed the Moiré interference pattern). However, when a corresponding pair of at least one Moiré interference pattern and a corresponding at least one inverted Moiré interference pattern are not center-aligned on substrate, the patterns interfere producing Moiré interference. The Moiré interference indicates misalignment between the given station and the first flexographic printing station. In certain embodiments, the determination may be made by an operator. In other embodiments, the determination may be automated. One of ordinary skill in the art will recognize that the determination may be made in other ways in accordance with one or more embodiments of the present invention.

In step 1640, an alignment of at least one of the at least one subsequent flexographic printing stations may be adjusted when at least one Moiré interference pattern interferes with a corresponding at least one inverted Moiré interference pattern on substrate. The Moiré interference may produce an arrowhead effect that points to the centers of the patterns and provide a vector for alignment. An operator, or automation equipment, may adjust parameters of the at least one subsequent flexographic printing station to bring it into alignment with the first flexographic printing station. This process may be iterated for all subsequent flexographic printing stations that are out of alignment. At the end of this process, all of the at least one subsequent flexographic printing stations are aligned to the first flexographic printing station.

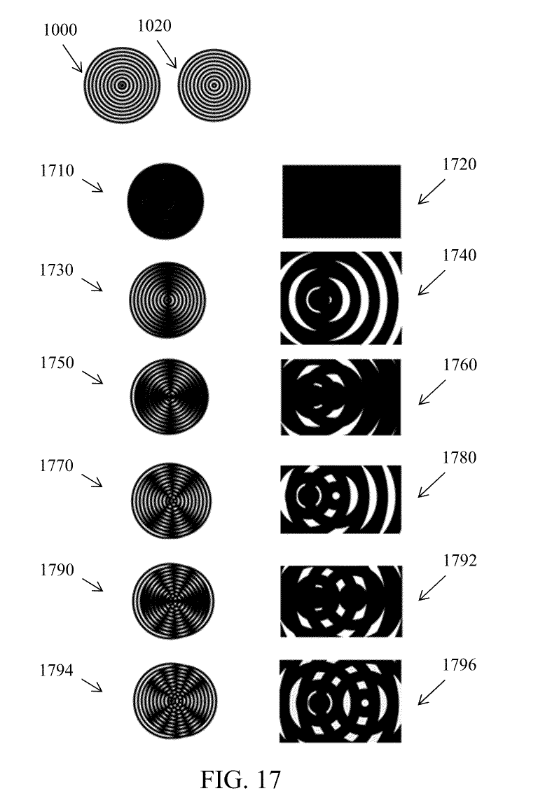

FIG. 17 shows the relationship between the trace width, the space width, the pitch width, and the offset displacement between the centers of a Moiré interference pattern 1000 and an inverted Moiré interference pattern 1020 and the perception of Moiré interference in accordance with one or more embodiments of the present invention. Moiré interference pattern 1000 and inverted Moiré interference pattern 1020 may be printed on substrate by, for example, a multi-station flexographic printing system. Moiré interference pattern 1000 may be printed by a first flexographic printing station of the multi-station flexographic printing system and inverted Moiré interference pattern 1020 may be printed by a subsequent flexographic printing station of the system. When the subsequent flexographic printing station is aligned to the first flexographic printing station, a center of inverted Moiré interference pattern 1020 overlaps and is center-aligned to a center of Moiré interference pattern 1000. The overlapping and center-aligned patterns 1000 and 1020 form an opaque circle 1710 on substrate that does not exhibit Moiré interference. A zoomed in view 1720 of a center of opaque circle 1710 shows that this overlap and center-alignment do not generate Moiré interference, providing a visual indicator of alignment.

If inverted Moiré interference pattern 1020 partially overlaps Moiré interference pattern 1000 as shown in partial overlap 1730, Moiré interference may be generated. Because the center of inverted Moiré interference pattern 1020 is not aligned to the center of Moiré interference pattern 1000, the patterns 1000 and 1020 may interfere, generating Moiré interference that is visually apparent. In this instance, the Moiré interference creates the perception of vectors that radiate out from the midpoint between the centers of the partially overlapping patterns 1000 and 1020 of partial overlap 1730. The relationship between the number of vectors formed is directly related to the offset displacement, or distance, between the centers of the Moiré interference pattern 1000 and inverted Moiré interference pattern 1020 that may be characterized by the pitch width, PW. The pitch width, PW, is a measure of the trace width, TW, and the space width, SW, such that (2×PW=TW+SW). In this example, the offset displacement distance between the centers of Moiré interference pattern 1000 and inverted Moiré interference pattern 1020 of partial overlap 1730 may be equal to one pitch width, PW, which gives the perception of one dark vector (per hemisphere) radiating out from the midpoint between the centers of the partially overlapping patterns 1000 and 1020 of partial overlap 1730. This results in one dark vector for each space width, SW, of offset displacement as shown in partial overlap 1730. A zoomed in view 1740 of a center of partial overlap 1730 shows how the offset displacement of one space width, SW, between the centers of patterns 1000 and 1020 of partial overlap 1730 may form one dark vector (per hemisphere) on substrate.

If inverted Moiré interference pattern 1020 partially overlaps Moiré interference pattern 1000 as shown in partial overlap 1750, Moiré interference may be generated. The partial overlap of patterns 1000 and 1020 creates the perception of vectors that radiate out from the midpoint between the centers of the overlapping patterns 1000 and 1020 of partial overlap 1750. In this example, the offset displacement distance between the centers of Moiré interference pattern 1000 and inverted Moiré interference pattern 1020 of partial overlap 1750 may be equal to the quantity two times the pitch width, PW, (2×PW) which gives the perception of two dark vectors (per hemisphere) radiating out from the midpoint between the centers of the overlapping patterns 1000 and 1020 of partial overlap 1750. This results in two dark vectors per each trace width, TW, and each space width, SW, of offset displacement. So the total displacement error would be the number of dark vectors, (2), times the pitch width, PW, resulting in (2×PW) error. A zoomed in view 1760 of a center of partial overlap 1750 shows how the offset displacement of one trace width, TW, and one space width, SW, between the centers of patterns 1000 and 1020 of partial overlap 1750 may form two dark vectors (per hemisphere) on substrate.

If inverted Moiré interference pattern 1020 partially overlaps Moiré interference pattern 1000 as shown in partial overlap 1770, Moiré interference may be generated. The partial overlap of patterns 1000 and 1020 creates the perception of vectors that radiate out from the midpoint between the centers of the overlapping patterns 1000 and 1020 of partial overlap 1770. In this example, the offset displacement distance between the centers of Moiré interference pattern 1000 and inverted Moiré interference pattern 1020 of partial overlap 1770 may be equal to three times the pitch width, PW, (3×PW) which gives the perception of three dark vectors (per hemisphere) radiating out from the midpoint between the centers of the overlapping patterns 1000 and 1020 of partial overlap 1770. A zoomed in view 1780 of a center of partial overlap 1770 shows how the offset displacement of one trace width, TW, and two space widths, SW, between the centers of patterns 1000 and 1020 of partial overlap 1770 is what formed the three dark vectors on substrate. So the total displacement error would be the number of dark vectors, (3), times the pitch width, PW, resulting in (3×PW) error.

If inverted Moiré interference pattern 1020 partially overlaps Moiré interference pattern 1000 as shown in partial overlap 1790, Moiré interference may be generated. The partial overlap of patterns 1000 and 1020 creates the perception of vectors that radiate out from the midpoint between the centers of the overlapping patterns 1000 and 1020 of partial overlap 1790. In this example, the offset displacement distance between the centers of Moiré interference pattern 1000 and inverted Moiré interference pattern 1020 of partial overlap 1790 may be equal to four times the pitch width, PW, (4×PW) which gives the perception of four dark vectors (per hemisphere) radiating out from the midpoint between the centers of the overlapping patterns 1000 and 1020 of partial overlap 1790. A zoomed in view 1792 of a center of partial overlap 1790 shows how the offset displacement of two trace widths, TW, plus two space widths, SW, between the centers of patterns 1000 and 1020 of partial overlap 1790 may form four dark vectors on substrate. So the total displacement error would be the number of dark vectors, (4), times the pitch width, PW, resulting in (4×PW) error.

If inverted Moiré interference pattern 1020 partially overlaps Moiré interference pattern 1000 as shown in partial overlap 1794, Moiré interference may be generated. The partial overlap of patterns 1000 and 1020 creates the perception of vectors that radiate out from the midpoint between the centers of the overlapping patterns 1000 and 1020 of partial overlap 1794. In this example, the offset displacement distance between the centers of Moiré interference pattern 1000 and inverted Moiré interference pattern 1020 of partial overlap 1794 maybe be equal to five times the pitch width, PW, (5×PW) which gives the perception of five dark vectors (per hemisphere) radiating out from the midpoint between the centers of the overlapping patterns 1000 and 1020 of partial overlap 1794. A zoomed in view 1796 of a center of partial overlap 1794 shows how the offset displacement of two trace widths, TW, plus three space widths, SW, between the centers of patterns 1000 and 1020 of partial overlap 1794 may form five dark vectors on substrate. So the total displacement error would be the number of dark vectors, (5), times the pitch width, PW, resulting in (5×PW) error.

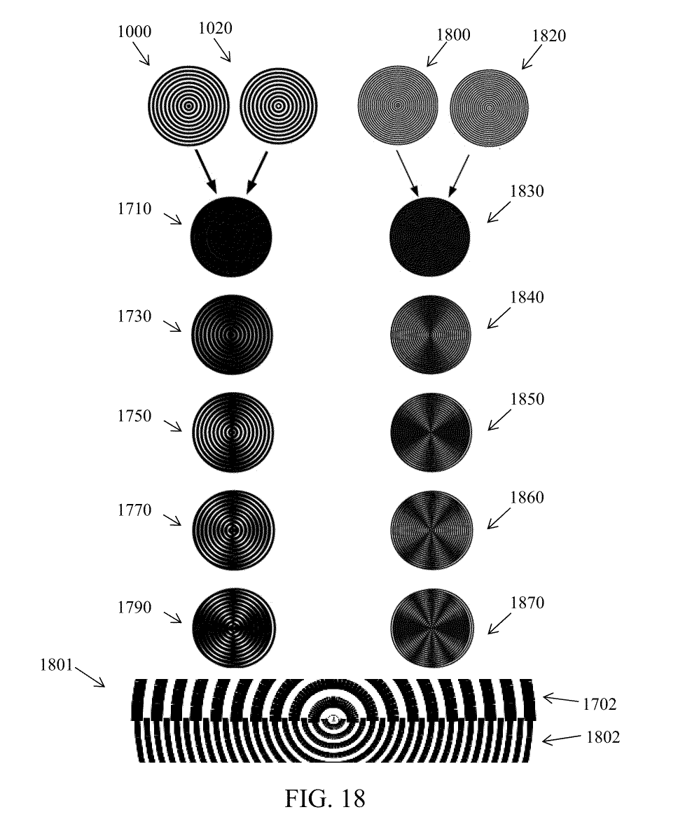

Continuing, FIG. 18 shows why decreasing the dimensions of the trace width, TW, and the space width, SW, results in the increase of the precision of the measurements. Two side-by-side examples show the difference in accuracy of the measurements for the same offset displacement between the two Moiré interference centers. The trace width, TW, space width, SW, and resultant pitch width, PW, of Moiré interference pattern 1000 and inverted Moiré interference pattern 1020 may be reduced to increase alignment accuracy. In this example, comparison view 1801 shows an exploded view of the cross-sectional relationship between Moiré interference pattern pair 1000 and 1020 shown in view 1702 and Moiré interference pattern pair 1800 and 1820 shown in view 1802, that they have approximately the same maximum radius, MR, but Moiré interference pattern pair 1800 and 1820 has twice the maximum number of concentric rings, MN, than that of Moiré interference pattern pair 1000 and 1020, which results in ½ TW, ½ SW, and ½ PW in Moiré pattern 1802 versus Moiré pattern 1702. This will result in twice the accuracy for measurements made by overlapping Moiré interference pattern 1800 with inverted Moiré interference pattern 1820, for the same center offset displacement versus Moiré interference pattern 1000 with inverted Moiré interference pattern 1020. Consequently, the precision may be increased while measuring the same offset displacement error.

If the center of inverted Moiré interference pattern 1020 is aligned to the center of Moiré interference pattern 1000, the combination of overlapping Moiré interference pattern 1000 and inverted Moiré interference pattern 1020 forms an opaque circle 1710 on substrate that does not exhibit Moiré interference, providing a visual indicator of alignment. If the center of inverted Moiré interference pattern 1820 is aligned to the center of Moiré interference pattern 1800, the combination of overlapping Moiré interference pattern 1800 and inverted Moiré interference pattern 1820 forms an opaque circle 1830 on substrate that does not exhibit Moiré interference, providing a visual indicator of alignment.

Partial overlaps 1730, 1750, 1770, an 1790 correspond to partial overlaps 1840, 1850, 1860, and 1870 respectively such that each pair have the same center offset displacement distance between their respective overlapping Moiré interference patterns. The pitch width, PW, for partial overlaps 1730, 1750, 1770, and 1790 in the following calculations will be selected from view 1702, whereas pitch width, PW, for partial overlaps 1840, 1850, 1860, and 1870 in the following calculations will be selected from view 1802.

Partial overlap 1730 and partial overlap 1840 have a center offset displacement distance between the overlapping Moiré interference patterns of 50% pitch width, PW (from view 1702). This results in Moiré interference which creates the perception of a vector that radiates out from the midpoint between the centers of the respective overlapping patterns 1000 and 1020 or from the midpoint between the centers of the overlapping patterns 1800 and 1820. Both partial overlap 1730 and partial overlap 1840 give the perception of one (1) dark vector (per hemisphere) radiating out from the midpoint between the centers of the overlapping patterns 1000 and 1020, and overlapping patterns 1800 and 1820. This indicating the offset displacement between the two Moiré centers of less than or equal to one (1) pitch width, PW, formed from each of the respective perceived interference patterns.

Partial overlap 1750 and partial overlap 1850 have a center offset displacement distance between the overlapping Moiré patterns of 100% of pitch width, PW (from view 1702). This results in Moiré interference which creates the perception of vectors that radiate out from the midpoint between the centers of the respective overlapping patterns 1000 and 1020 or from the midpoint between the centers of the overlapping patterns 1800 and 1820. Partial overlap 1750, just like partial overlap 1730, still gives the perception of only one (1) dark vector (per hemisphere) radiating out from the midpoint between the centers of the overlapping patterns 1000 and 1020. This indicating the offset displacement between the two Moiré centers of less than or equal to one (1) pitch width, PW, forming one (1) dark vector. Whereas partial overlap 1850 gives the perception of two (2) dark vectors (per hemisphere) radiating out from the midpoint between the centers of overlapping patterns 1800 and 1820, for the same center offset displacement distance, due to the pitch width, PW, being only one half of that in partial overlap 1750. This results in a total of two (2) dark vectors, caused by the one (1) dark vector per each trace width, TW, and each space width, SW, of offset displacement in partial overlap 1850, indicating the offset displacement between the two Moiré centers of two (2) pitch widths, PW (from view 1802) forming two (2) dark vectors.

Partial overlap 1770 and partial overlap 1860 have a center offset displacement distance between the overlapping Moiré interference patterns of 150% of the pitch width, PW (from view 1702). This results in Moiré interference which creates the perception of vectors that radiate out from the midpoint between the centers of the respective overlapping patterns 1000 and 1020 or from the midpoint between the centers of the overlapping patterns 1800 and 1820. Partial overlap 1770 gives the perception of one (1) dark and one (1) faint vector radiating out from the midpoint between the centers of the overlapping patterns 1000 and 1020. This indicating the offset displacement between the two Moiré centers of close proximity to two (2) times the pitch width, PW, forming two (2) vectors. Whereas partial overlap 1860 gives the perception of three (3) dark vectors (per hemisphere) radiating out from the midpoint between the centers of the overlapping patterns 1800 and 1820, for the same center offset displacement distance, due to the pitch width, PW, being only one half that of that in partial overlap 1770. This results in a displacement in partial overlap 1860, indicating the offset displacement between the two Moiré centers of three (3) times the pitch width, PW (from view 1802), and forming three (3) dark vectors.

Partial overlap 1790 and partial overlap 1870 have a center offset displacement distance between the overlapping Moiré patterns of 200% the pitch width, PW (from view 1702). This results in Moiré interference which creates the perception of vectors that radiate out from the midpoint between the centers of the respective overlapping patterns 1000 and 1020 or from the midpoint between the centers of overlapping patterns 1800 and 1820. Partial overlap 1790, gives the perception of two (2) dark vectors (per hemisphere) radiating out from the midpoint between the centers of the overlapping patterns 1000 and 1020. This indicating the offset displacement between the two Moiré centers of equal to two (2) pitch widths, PW, forming two (2) dark vectors. Whereas partial overlap 1870 gives the perception of four (4) dark vectors (per hemisphere) radiating out from the midpoint between the centers of the overlapping patterns 1800 and 1820, for the same center offset displacement distance, due to the pitch width, PW, being only one half of that of partial overlap 1790. This results in a total of four (4) dark vectors, caused by the two (2) trace widths, TW, and two (2) space widths, SW, of offset displacement in partial overlap 1870, indicating the offset displacement between the two Moiré centers of four (4) pitch widths, PW (from view 1802), forming four (4) dark vectors.

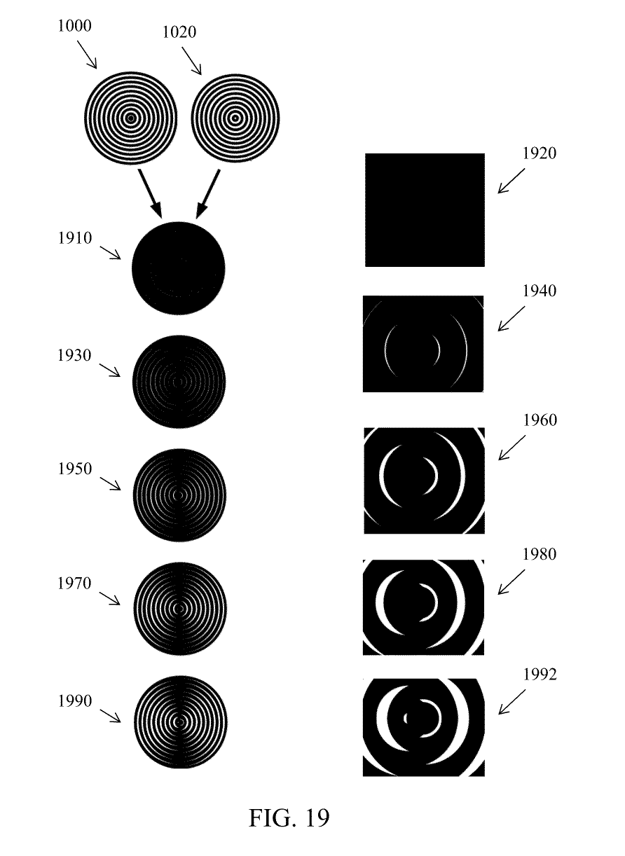

FIG. 19 shows the relationship between the offset displacement between two Moiré centers and the perception of one or more patterns, caused by overlapping images, when the offset displacement is less than the width of a single trace width, TW. When a center of inverted Moiré interference pattern 1020 overlaps and is center-aligned to a center of Moiré interference pattern 1000, the overlapping and center-aligned patterns 1000 and 1020 form an opaque circle 1910 on substrate that does not exhibit Moiré interference. A zoomed in view 1920 of a center of opaque circle 1910 shows that this overlap and center-alignment do not generate Moiré interference, providing a visual indicator of alignment.

If inverted Moiré interference pattern 1020 partially overlaps Moiré interference pattern 1000 as shown in partial overlap 1930, Moiré interference may be generated. Because the center of inverted Moiré interference pattern 1020 is not aligned to the center of Moiré interference pattern 1000, the patterns 1000 and 1020 may interfere, generating Moiré interference that is visually apparent. A zoomed in view 1940 of a center of partial overlap 1930 shows an offset displacement of approximately 0.125 TW, less than a quarter of the trace width. The Moiré interference creates the perception of two faint and wide vectors that radiate out from the midpoint between the centers of the partially overlapping patterns 1000 and 1020 of partial overlap 1930. These faint and wide vectors indicate that the offset displacement between the overlapping patterns 1000 and 1020 of partial overlap 1930 is significantly less than one pitch width, PW.

If inverted Moiré interference pattern 1020 partially overlaps Moiré interference pattern 1000 as shown in partial overlap 1950, Moiré interference may be generated. Because the center of inverted Moiré interference pattern 1020 is not aligned to the center of Moiré interference pattern 1000, the patterns 1000 and 1020 may interfere, generating Moiré interference that is visually apparent. A zoomed in view 1960 of a center of partial overlap 1950 shows an offset displacement of approximately 0.25 TW, one quarter of the trace width. The Moiré interference creates the perception of two less faint, but narrower, vectors that radiate out from the midpoint between the centers of the partially overlapping patterns 1000 and 1020 of partial overlap 1950. These less faint, but narrower, vectors indicate that the offset displacement between the overlapping patterns 1000 and 1020 of partial overlap 1950 is less than one pitch width, PW.

If inverted Moiré interference pattern 1020 partially overlaps Moiré interference pattern 1000 as shown in partial overlap 1970, Moiré interference may be generated. Because the center of inverted Moiré interference pattern 1020 is not aligned to the center of Moiré interference pattern 1000, the patterns 1000 and 1020 may interfere, generating Moiré interference that is visually apparent. A zoomed in view 1980 of a center of partial overlap 1970 shows an offset displacement of approximately 0.375 TW, more than a quarter but less than a half of the trace width. The Moiré interference creates the perception of two less faint, but narrower, vectors that radiate out from the midpoint between the centers of the partially overlapping patterns 1000 and 1020 of partial overlap 1970. These less faint, but narrower, vectors indicate that the offset displacement between the overlapping patterns 1000 and 1020 of partial overlap 1970 is less than one pitch width, PW.

If inverted Moiré interference pattern 1020 partially overlaps Moiré interference pattern 1000 as shown in partial overlap 1990, Moiré interference may be generated. Because the center of inverted Moiré interference pattern 1020 is not aligned to the center of Moiré interference pattern 1000, the patterns 1000 and 1020 may interfere, generating Moiré interference that is visually apparent. A zoomed in view 1992 of a center of partial overlap 1990 shows an offset displacement of approximately 0.50 TW, one half of the trace width. The Moiré interference creates the perception of two less faint, but narrower, vectors that radiate out from the midpoint between the centers of the partially overlapping patterns 1000 and 1020 of partial overlap 1990. These less faint, but narrower, vectors indicate that the offset displacement between the overlapping patterns 1000 and 1020 of partial overlap 1990 is less than one pitch width, PW. As the offset displacement between the overlapping patterns 1000 and 1020 approaches one pitch width, PW, the vectors become more pronounced and narrower. As such, the prominence and width of the dark vectors may be a visual indication as to the offset displacement between the overlapping patterns 1000 and 1020. This offset displacement may be used with a camera detection system to detect the slight intensity and shape changes calibrated to detect displacement variations smaller than the smallest printable feature used to make the concentric rings 1010 to determine the alignment accuracy in a very precise manner, on the order of magnitude of the trace width or space width of the Moiré interference pattern and inverted Moiré interference pattern used. Thus, the method disclosed herein may be used to achieve alignment accuracy and precision on the order of magnitude of sub-micrometer.

One of ordinary skill in the art will recognize that, with respect to the above-noted method, the role of the at least one Moiré interference pattern and the at least one inverted Moiré interference pattern may be reversed in accordance with one or more embodiments of the present invention.

Advantages of one or more embodiments of the present invention may include one or more of the following:

In one or more embodiments of the present invention, a method of aligning a multi-station flexographic printing system using Moiré interference allows for the accurate and precise printing of fine lines or features on substrate.

In one or more embodiments of the present invention, a method of aligning a multi-station flexographic printing system using Moiré interference allows for the use of a plurality of flexographic printing stations to print fine lines or features on substrate in their intended locations with high accuracy and precision.

In one or more embodiments of the present invention, a method of aligning a multi-station flexographic printing system using Moiré interference allows for the use of a plurality of flexographic printing stations to print fine lines or features on substrate in a roll-to-roll process.

In one or more embodiments of the present invention, a method of aligning a multi-station flexographic printing system using Moiré interference provides for a simple, efficient, and cost-effective method for visual or optical alignment of flexographic printing stations.

In one or more embodiments of the present invention, a method of aligning a multi-station flexographic printing system using Moiré interference allows for the visual determination of whether one or more flexographic printing stations are printing shrunken or enlarged images on substrate.

In one or more embodiments of the present invention, a method of aligning a multi-station flexographic printing system using Moiré interference allows an operator to visually determine whether there is misalignment between stations and provides a vector to adjust the alignment of at least one flexographic printing station in response.

In one or more embodiments of the present invention, a method of aligning a multi-station flexographic printing system using Moiré interference allows for the automation to optically determine whether there is misalignment between stations and provides a vector to adjust the alignment of at least one flexographic printing station in response.

In one or more embodiments of the present invention, a method of aligning a multi-station flexographic printing system using Moiré interference allows for a level of precision that is only limited by the smallest printable feature size of a flexographic printing station.

In one or more embodiments of the present invention, a method of aligning a multi-station flexographic printing system using Moiré interference makes it possible to achieve very precise measurements using analog type low resolution global scans, by a human or camera, versus other methods that require a digital camera scan at very high magnification, triggered off of a sensor, so that the localized zoomed scan image can be processed to count the pixels as part of the determination of alignment.

In one or more embodiments of the present invention, a method of aligning a multi-station flexographic printing system using Moiré interference ensures that a first conductive pattern disposed on a substrate is aligned to a second conductive pattern disposed on the substrate at a predetermined alignment that may include an offset.

In one or more embodiments of the present invention, method of aligning a multi-station flexographic printing system using Moiré interference prints Moiré interference patterns and inverted Moiré interference patterns using the same process used to print at least a portion of an image of the conductive patterns on substrate.

In one or more embodiments of the present invention, a method of aligning a multi-station flexographic printing system using Moiré interference is compatible with existing flexographic printing processes used to print on substrate.

In one or more embodiments of the present invention, a method of aligning a multi-station flexographic printing system using Moiré interference is compatible with other existing conductive pattern fabrication processes used to form conductive patterns on substrate.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

What is claimed is:

1. A method of aligning a multi-station flexographic printing system using Moiré interference comprising:
printing, using a first flexographic printing station, at least one Moiré interference pattern in a unique location on a first side of a substrate for each of at least one subsequent flexographic printing stations of the system;
for each of the at least one subsequent flexographic printing stations, printing at least one inverted Moiré interference pattern on either side of the substrate in a location corresponding to that station's unique location on the substrate; and
adjusting an alignment of at least one of the at least one subsequent flexographic printing stations when at least one Moiré interference pattern interferes with a corresponding at least one inverted Moiré interference pattern.

2. The method of claim 1, further comprising:
determining which of the at least one subsequent flexographic printing stations is misaligned using Moiré interference.

3. The method of claim 1, wherein at least one of the flexographic printing stations prints an image of at least a portion of a conductive pattern.

4. The method of claim 3, wherein the image of the at least portion of the conductive pattern comprises an image of a plurality of conductive lines having a line width less than 5 micrometers.

5. The method of claim 3, wherein the image of the at least portion of the conductive pattern comprises an image of a plurality of conductive lines having a line width in a range between approximately 5 micrometers and approximately 10 micrometers.

6. The method of claim 1, wherein each of the at least one Moiré interference patterns comprises a plurality of concentric rings.

7. The system of claim 1, wherein each of the at least one inverted Moiré interference patterns comprises an inverse image of the at least one Moiré interference pattern.

8. The method of claim 1, wherein, when a corresponding pair of one of the at least one Moiré interference patterns and one of the at least one inverted Moiré interference patterns are not center-aligned, the patterns interfere producing Moiré interference as an indication of misalignment.

9. The method of claim 1, wherein, when a corresponding pair of one of the at least one Moiré interference patterns and one of the at least one inverted Moiré interference patterns are center-aligned, the lack of Moiré interference is an indication of alignment.

10. The method of claim 1, wherein the role of the at least one Moiré interference patterns and the at least one inverted Moiré interference patterns is reversed.

11. A multi-station flexographic printing system comprising:
a first flexographic printing station configured to print on a substrate; and
at least one subsequent flexographic printing station configured to print on the substrate,
wherein the first flexographic printing station prints at least one Moiré interference pattern in a unique location on a first side of the substrate for each of the at least one subsequent flexographic printing stations of the system, and
wherein each of the at least one subsequent flexographic printing stations prints at least one inverted Moiré interference pattern on either side of the substrate in a location corresponding to that station's unique location on the substrate.

12. The system of claim 11, wherein the first flexographic printing station comprises:
an anilox roll;
a doctor blade;
a printing plate cylinder;
a flexographic printing plate mounted to the printing plate cylinder; and
an impression cylinder,
wherein the flexographic printing plate comprises an image of the at least one Moiré interference pattern.

13. The system of claim 12, wherein the flexographic printing plate further comprises an image of at least a portion of a conductive pattern.

14. The system of claim 11, wherein each of the at least one subsequent flexographic printing stations comprises:
an anilox roll;
a doctor blade;
a printing plate cylinder;
a flexographic printing plate mounted to the printing plate cylinder; and
an impression cylinder,
wherein the flexographic printing plate comprises an image of the at least one inverted Moiré interference pattern.

15. The system of claim 14, wherein the flexographic printing plate further comprises an image of at least a part of a conductive pattern.

16. The system of claim 11, wherein each of the at least one Moiré interference patterns comprises a plurality of concentric rings.

17. The system of claim 11, wherein each of the at least one inverted Moiré interference patterns comprises an inverse image of the at least one Moiré interference pattern.

18. The system of claim 11, wherein, when a corresponding pair of one of the at least one Moiré interference patterns and one of the at least one inverted Moiré interference patterns are not center-aligned, the patterns interfere producing Moiré interference as an indication of misalignment.

19. The system of claim 11, wherein, when a corresponding pair of one of the at least one Moiré interference patterns and one of the at least one inverted Moiré interference patterns are center-aligned, the lack of Moiré interference is an indication of alignment.

20. The system of claim 11, wherein the role of the at least one Moiré interference patterns and the at least one inverted Moiré interference patterns is reversed.
